(19) United States
(12) Patent Application Publication
(10) Pub. No.: US 2018/0339670 A1
(43) Pub. Date: Nov. 29, 2018

(54) COLLISION PREVENTING CONTROL DEVICE

(71) Applicant: TOYOTA JIDOSHA KABUSHIKI KAISHA, Toyota-shi (JP)

(72) Inventors: Motoki NISHIMURA, Susono-shi (JP); Kotaro SAIKI, Susono-shi (JP)

(73) Assignee: TOYOTA JIDOSHA KABUSHIKI KAISHA, Toyota-shi (JP)

(21) Appl. No.: 15/986,095

(22) Filed: May 22, 2018

(30) Foreign Application Priority Data
May 24, 2017 (JP) 2017-102254

(51) Int. Cl. B60R 21/0134; B60W 30/09; G08G 1/16; B60R 21/0132

(52) U.S. Cl. CPC B60R 21/0134; B60W 30/09; G08G 1/162; B60R 2021/01327; B60R 2021/01322; B60R 2021/01325; B60R 21/0132

(57) ABSTRACT

A collision preventing ECU 10 determines that a support performing condition is established when a relationship between a threshold and a collision index value representing emergency degree of a collision between an object and the own vehicle satisfies with a predetermined relationship. In this case, the ECU performs a collision preventing control for preventing the collision. The ECU determines whether or not the object is a continuous structure. The ECU determines whether or not a running status is a steering operation running status. The ECU changes at least one of the collision index value and the threshold such that the support performing condition becomes more difficult to be established when a specific condition that the object is determined to be the continuous structure and the running status is determined to be the steering operation running status is established than when the specific condition is not established.

### BACKGROUND OF THE INVENTION

### Field of the Invention

The present invention relates to a collision preventing control device for performing a collision preventing control to prevent an own vehicle from colliding with an object satisfying a condition for performing a driving support.

### Related Art

Hitherto, for example, as proposed in Japanese Patent Application Laid-open No. 2014-96064, a collision preventing control device (hereinafter referred to as a “conventional device”) performs a driving support for preventing an own vehicle from colliding with an object, when the object is present in a predetermined area including a path along which the own vehicle will run and when it is determined that the own vehicle should avoid the object.

More specifically, the conventional device divides the predetermined area into two areas in a width direction of the own vehicle. Further, the conventional device changes a condition to be satisfied to trigger/start performing the driving support such that the condition becomes satisfied more easily so as to be able to start performing the driving support earlier when only either one of the two areas includes a path for avoiding the collision with the object than when each and every one of the two areas includes a path for avoiding the collision. Therefore, the conventional device can start performing the driving support immediately before the path for avoiding the collision is no longer found.

A driver may perform a steering operation (an intentional steering operation) with his/her intention to avoid an oncoming vehicle which is straying over a centerline of a curved road and approaching the own vehicle. In this case, the own vehicle may head to (run toward) a continuous structure (for example, a crash barrier, a gully, edge stones, a wall, or the like). When the own vehicle runs to the continuous structure, an area (e.g., a front-left side area of the own vehicle) where the continuous structure is present is not an area where the own vehicle can avoid a collision with the continuous structure. On the other hand, the other area (e.g., a front-right area of the own vehicle) opposite to the area where the continuous structure is present may often be an area where the own vehicle can avoid a collision with the continuous structure. In this case, the path which enables the own vehicle to avoid the collision with the continuous structure passes through only either one of the two areas. Therefore, the conventional device changes the condition to be satisfied to trigger/start performing the driving support such that the condition becomes satisfied more easily. As a result, the conventional device is likely to start performing a collision preventing control even while the driver is performing the steering operation with his/her intention. Hence, the collision preventing control may annoy the driver.

### SUMMARY OF THE INVENTION

The present invention has been made to solve the problem described above. The present invention has an object to provide a collision preventing control device that reduces a “possibility that the collision preventing control is performed while the driver is performing the steering operation with his/her intention” to thereby reduce a “possibility that the collision preventing control annoys the driver”.

A collision preventing control device (hereinafter, referred to as a “present invention device”) according to the present invention comprises, a collision preventing control unit (10) for determining that a support performing condition is established when a relationship between a predetermined threshold (threshold time period Tth) and a collision index value (time to collision TTC) indicative of emergency degree of a collision between an object which has a high probability of colliding with an own vehicle and the own vehicle satisfies a predetermined relationship, to perform a collision preventing control (Step 434) including at least one of a control for changing running behavior of the own vehicle to prevent the collision and a control for displaying an alert screen to make a driver pay attention to the object.

The collision preventing control unit comprises: a continuous structure determining unit (10 and Step 414) for determining whether or not the object is a continuous structure whose length is equal to or longer than a predetermined length;

a steering operation determining unit (10 and Step 900 through Step 995) for determining whether or not a running status of the own vehicle is a steering operation running status that the own vehicle is running with a steering operation performed by the driver; and a condition changing unit (10, Step 436, and Step 1005) for changing at least one of the collision index value and the predetermined threshold such that the support performing condition becomes more difficult to be established when a specific condition that the object is determined to be the continuous structure and the running status is determined to be the steering operation running status is established than when the specific condition is not established.

Thus, the configured present invention device can reduce possibility that the collision preventing control is performed while the driver is performing the steering operation with his/her intention. Therefore, the possibility that the collision preventing control annoys the driver can be reduced.

One aspect of the present invention resides in that the steering operation determining unit is configured to:

obtain a steering index value correlating with a steering amount of the steering operation, every time a first predetermined time period elapses (Step 905); and

determine (Step 920) that the running status is the steering operation running status when a change amount (AOC or AOC′) in the steering index value is equal to or larger than a threshold amount (AOC1th or AOC′1th), the change amount correlating with a magnitude of a difference between a steering index value obtained at a present time point and a steering index value obtained at a time point the first predetermined time period before the present time period.

When and after the driver starts an intentional steering operation, the change amount in the steering amount usually becomes large as compared with before starting the intentional steering operation. In view of this, when the change amount (AOC or AOC′) in the steering index value is equal to or larger than the threshold amount (AOC1th or AOC′1th), the change amount correlating with a magnitude of a difference between a steering index value obtained at a present time point and a steering index value obtained at a time point the first predetermined time period before the present time period, the present intention device determines that the own vehicle is in the intentional steering operation running status (in other words, it determines that the driver has started the intentional steering operation). Therefore, the present invention device can more accurately determine whether or not the own vehicle is in the intentional steering operation status.

One aspect of the present invention resides in that the steering operation determining unit is configured to use either a yaw rate which is generated in the own vehicle or a steering angle of a steering wheel of the own vehicle as the steering index value (Step 905 and Step 910).

Therefore, the present invention device can more accurately detect the steering amount by the driver. Accordingly, the present invention can more accurately determine whether or not the own vehicle is in the intentional steering operation status.

One aspect of the present invention resides in that the steering operation determining unit is configured to continue determining that the running status is the steering operation running status from a first time point when the change amount of the steering index value becomes equal to or larger than the threshold amount till a second time point when a second predetermined time period elapses from the first time point (Step 920, Step 930, Step 935, and Step 940).

As described above, the change amount in the steering amount is likely to become relatively large after starting the intentional steering operation as compared with before starting the intentional steering operation. However, the change amount in the steering amount is sometimes relatively small while the intentional steering operation is being performed after starting the intentional steering operation. According to the above aspect, the own vehicle continues to be determined that it is in the steering operation status until the second predetermined time period elapses from the time point when it is once determined that own vehicle is in the steering operation status. Therefore, the possibility that the collision preventing control is performed while the driver is performing the steering operation with the intention can be more reduced. Accordingly, the possibility that the collision preventing control annoys the driver can be further reduced.

One aspect of the present invention resides in that the steering operation determining unit is configured to determine that the running status is not the steering status (Step 438), when the continuous structure at the present time point is determined (“No” at Step 426) to be different from the continuous structure at the time point when the object was determined to be the continuous structure by the continuous structure determining unit so that the specific condition became established (“Yes” at Step 416, and “Yes” at Step 428), in a period from the first time point till the second time point.

When the continuous structure selected at the present time point is different from the continuous structure selected at the previous time point, the driver may perform the intentional steering operation without recognizing the continuous structure selected at the present time point. In this case, according to the above aspect, the specific condition is not established because it is determined that the own vehicle is not in the steering operation status. Therefore, the present invention device can perform the collision preventing control for a usual/standard obstacle at a usual/standard timing.

One aspect of the present invention resides in that the collision preventing control unit is configured to prohibit itself from performing the collision preventing control when the own vehicle is running straight (“Yes” at Step 422) and a magnitude of an angle of the continuous structure in relation to the own vehicle is smaller than a threshold angle (“No” at Step 424).

The detected location/position of the object which may sometimes be different from the real/actual location/position of the object. Due to this error, the detected continuous structure may sometimes be determined to be inclined to the own vehicle (in other words, the angle of the continuous structure angle θcp≠0). On the other hand, when the continuous structure is parallel to the own vehicle while the own vehicle is running straight, the own vehicle does not collide with the continuous structure. According to the above aspect, when the own vehicle is running straight and the magnitude of the angle of the continuous structure is smaller than the threshold angle, the present invention device determines that the own vehicle does not collide with the continuous structure, in consideration of a detection error of the object, so as to prohibit itself from performing the collision preventing control. Therefore, the present invention device can reduce the possibility of performing the collision preventing control for the obstacle with which the own vehicle is unlikely to collide, so that the present invention device can reduce the possibility that the collision preventing control annoys the driver.

In the above description, in order to facilitate the understanding of the invention, reference symbols used in embodiment of the present invention are enclosed in parentheses and are assigned to each of the constituent features of the invention corresponding to the embodiment. However, each of the constituent features of the invention is not limited to the embodiment as defined by the reference symbols.

### BRIEF DESCRIPTION OF THE DRAWINGS

FIG. 1 is a schematic system configuration diagram of a collision preventing device (first device) according to a first embodiment of the present invention.

FIG. 2 is a diagram illustrating an outline of a continuous structure determining process for determining whether or not an obstacle is a continuous structure.

FIG. 3A is a diagram illustrating time series locations/positons of an own vehicle while a driver is performing an intentional steering operation when the obstacle is the continuous structure.

FIG. 3B is a diagram illustrating time series locations/positons of the own vehicle while the driver is performing the intentional steering operation when the obstacle is the continuous structure.

FIG. 4 is a flowchart illustrating a routine which is executed by a CPU of a collision preventing ECU illustrated in FIG. 1.

FIG. 5 is a flowchart illustrating a routine which is executed by the CPU of the collision preventing ECU in a continuous structure determining process included in the routine illustrated in FIG. 4.

FIG. 6 is a flowchart illustrating a routine which is executed by the CPU of the collision preventing ECU in a forward direction selecting process included in the routine illustrated in FIG. 5.

FIG. 7 is a diagram illustrating a relation between an approximate line and a longitudinal direction of the own vehicle when a continuous structure angle is a positive value.

FIG. 8 is a diagram illustrating a relation between the approximate line and the longitudinal direction of the own vehicle when the continuous structure angle is a negative value.

FIG. 9 is a flowchart illustrating a routine which is executed by the CPU of the collision preventing ECU illustrated in FIG. 1.

FIG. 10 is a flowchart illustrating a routine which is executed by a CPU of a collision preventing device (second device) according to a second embodiment of the present invention.

FIG. 11 is a flowchart illustrating a routine which is executed by a CPU of a collision preventing device (third device) according to a third embodiment of the present invention.

FIG. 12 is a flowchart illustrating a routine which is executed by the CPU of the collision preventing ECU in an interpolation distance calculating process included in the routines illustrated in FIG. 11.

FIG. 13 is a diagram illustrating interpolation distance information.

FIG. 14A is a diagram illustrating an interpolation distance when a continuous points angle is small.

FIG. 14B is a diagram illustrating the interpolation distance when the continuous points angle is big.

FIG. 15 is a flowchart illustrating a routine which is executed by a CPU of a collision preventing device according to a modification example of the third embodiment of the present invention.

### DESCRIPTION OF THE PREFERRED EMBODIMENTS

A collision preventing control device according to each of embodiments of the present invention will next be described with reference to the accompanying drawings.

### First Embodiment

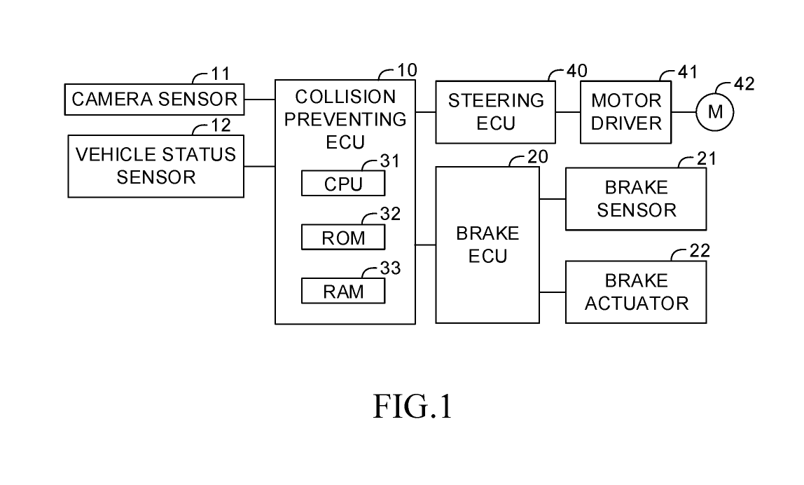

FIG. 1 is a schematic system configuration diagram of a collision preventing control device (hereinafter referred to as a “first device”) according to a first embodiment of the present invention. A vehicle in which the collision preventing control device is installed is referred to as an “own vehicle”, when this vehicle needs to be distinguished from other vehicles. The first device performs a collision preventing control for preventing the own vehicle from colliding with an obstacle which has high possibility/probability of colliding with the own vehicle SV, so as to support a driver's driving operation. The collision preventing control is a control for changing a running state of the own vehicle SV. The obstacle is an object present in an area including a path along which the own vehicle SV is going to run.

The first device includes a collision preventing ECU 10. It should be noted that an ECU is an abbreviation of an “Electronic Control Unit” which includes a microcomputer as a main part. The microcomputer of the ECU 10 includes a CPU 31, and memories (for example, a ROM 31, a RAM 32, and the like). The CPU 31 achieves various functions by executing instructions (program, routine) stored in the ROM 32.

The first device further includes a camera sensor 11, a vehicle status sensor 12, a brake ECU 20, a brake sensor 21, a brake actuator 22, a steering ECU 40, a motor driver 41, and a steering motor (M) 42. The camera sensor 11, the vehicle status sensor 12, the brake ECU 20, and the steering ECU 40 are connected to the collision preventing ECU 10.

The camera sensor 11 includes a vehicle-installed/onboard stereo camera device (not shown) which photographs an area ahead of the own vehicle, and an image processing device (not shown) which processes images photographed by the vehicle-installed stereo camera device.

The vehicle-installed stereo camera device is arranged in the vicinity of a center in a width direction of a front end of a roof of the own vehicle SV. The vehicle-installed stereo camera device includes a left camera arranged on a left side of a vehicle longitudinal axis and a right camera arranged on a right side of the vehicle longitudinal axis. The left camera photographs the area ahead of the own vehicle SV, and transmits a left image signal representing a left image photographed by the left camera to the image processing unit, every time a predetermined time period elapses. Similarly, the right camera photographs the area ahead of the own vehicle SV, and transmits a right image signal representing a right image photographed by the right camera to the image processing unit, every time the predetermined time period elapses.

The image processing unit detects/extracts a feature point(s) from the left image represented by the received left image signal, and detects/extracts a feature point(s) from the right image represented by the received right image signal. The feature point is extracted/detected using a well-known method such as Harris, Features from Accelerated Segment Test (FAST), Speeded Up Robust Features (SURF), Scale-Invariant Feature Transform (SIFT), or the like.

Thereafter, the image processing unit matches one of the feature points extracted from the left image and one of the feature points extracted from the right image to calculate a distance between the matched feature point and the own vehicle and a direction of the matched feature point in relation to the own vehicle, using a parallax between those feature points.

Further, the image processing device transmits location information including a distance from the feature point to the own vehicle SV and a direction of the feature point in relation to the own vehicle SV as object information to the collision preventing ECU 10, every time a predetermined time period elapses.

The collision preventing ECU 10 recognizes time series positions (moving transition) of the feature point which is included in the object information transmitted from the image processing device. The collision preventing ECU 10 recognizes a relative velocity of the feature point in relation to the own vehicle SV and a relative moving trajectory of the feature point in relation to the own vehicle SV, based on the recognized time series positions (moving transition) of the feature point.

The vehicle status sensor 12 includes sensors which obtain vehicle status information on a traveling status of the own vehicle SV, which is necessary to predict a predicted traveling path (course, trajectory) RCR of the own vehicle SV. The vehicle status sensor 12 includes a vehicle velocity sensor which detects velocity (speed) of the own vehicle SV, an acceleration sensor which detects an acceleration of the own vehicle SV in a longitudinal direction on an horizontal plane and an acceleration of the own vehicle SV in a width direction on the horizontal plane, a yaw rate sensor which detects a yaw rate of the own vehicle SV, and a steering angle sensor which detects a steering angle of each of steered wheels. The vehicle status sensor 12 transmits the vehicle status information to the collision preventing ECU 10 every time a predetermined time period elapses.

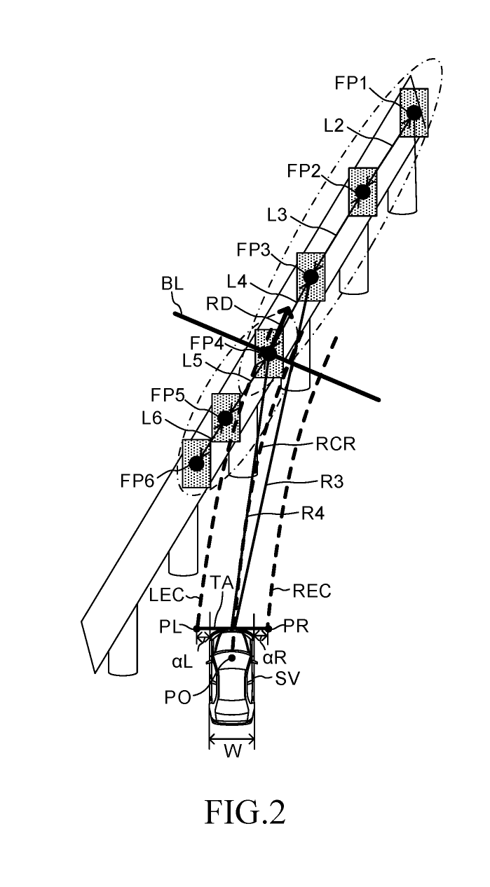

The collision preventing ECU 10 calculates a turning radius of the own vehicle SV based on the velocity of the own vehicle SV detected by the vehicle velocity sensor, and the yaw rate detected by the yaw rate sensor. Thereafter, the collision preventing ECU 10 predicts, as the predicted traveling path (course, trajectory) RCR, a traveling path (course, trajectory) along which a center point in the width direction of the own vehicle SV (the center point PO (referring to FIG. 2) of a wheel axis connecting a left wheel and a right wheel) will move, based on the turning radius. When the yaw rate is generated (when a magnitude of the yaw rate is larger than “0”), a shape of the predicted traveling path RCR is an arc. When the yaw rate is not generated (when the magnitude of the yaw rate is “0”), the collision preventing ECU 10 predicts a straight traveling path extending along a direction of the acceleration detected by the acceleration sensor as the traveling path along which the own vehicle SV will move (i.e. the predicted traveling path RCR). The collision preventing ECU 10 recognizes (determines), as the predicted traveling path RCR, a part of the traveling path having a finite distance from a present location of the own vehicle SV to a location where the own vehicle will move for a predetermined distance/length from the present location along the traveling path, regardless of whether the own vehicle is running straight or turning.

The brake ECU 20 is connected to a plurality of brake sensors 21. The brake ECU 20 receives detection signals transmitted from these brake sensors 21. The brake sensors 21 obtain parameters which the brake ECU 20 uses when the brake ECU 20 controls a brake device (not shown) installed in the own vehicle SV. The brake sensors 21 include a brake pedal operating amount sensor which detects a brake pedal operating amount, a wheel velocity sensor which detects a rotation speed of the wheel, and etc.

The brake ECU 20 is connected to a brake actuator 22. The brake actuator 22 is a hydraulic control actuator. The brake actuator 22 is provided in an unillustrated hydraulic circuit between an unillustrated master cylinder which pressurizes working oil by using a depressing force applied to the brake pedal and unillustrated friction brake mechanisms including each of well-known wheel cylinders provided in each of wheels. The brake actuator 22 adjusts oil pressure applied to the wheel cylinder. The brake ECU 20 drives the brake actuator 22 so as to generate braking force (frictional braking force) on each of the wheels to thereby adjust the acceleration (a negative acceleration, i.e. a deceleration) of the own vehicle SV.

The brake ECU 20 also drives the brake actuator 22 based on a signal transmitted from the collision preventing ECU 10 to adjust the acceleration of the own vehicle SV

The steering ECU 40 is a controller of an well-known electric power steering system and is connected to a motor driver 41. The motor driver 41 is connected to a steering motor 42. The steering motor 42 is installed in an unillustrated “steering mechanism of the own vehicle SV.” The steering mechanism includes a steering wheel, a steering shaft connected to the steering wheel, a steering gear mechanism, and the like. The steering motor 42 generates torque by using electric power supplied from the motor driver 41. This torque is used for generating steering assist torque and for turning left and right steered wheels of the own vehicle SV.

### <Outline of Operation>

An operation of the first device will next be described. The first device selects, as an obstacle point(s), a feature point(s) which is predicted to have probability of colliding with the own vehicle SV from the feature point(s) included in the object information. The feature point selected as the obstacle point may include a feature point which is predicted not to collide with the own vehicle SV but to have a narrow margin of clearance between the feature point and the own vehicle SV (or to extremely approach the own vehicle SV). Thereafter, the first device calculates a time to collision TTC (collision time period) which it takes for each of the obstacle points to collide with the own vehicle SV or to reach the closest point to the own vehicle SV. Subsequently, the first device determines whether or not an obstacle including (specified by) the obstacle point with the minimum time to collision TTC is a continuous structure which has a predetermined length or a length longer than the predetermined length along a lane (in which the own vehicle SV is traveling).

Further, the first device executes an intentional steering operation determining process for determining whether or not a running status of the own vehicle SV is an intentional steering operation status which represents a status where the own vehicle SV is running in accordance with a steering operation performed by the driver, every time a predetermined time period elapses. The intentional steering operation status may be referred to as a “steering operation running status”. The intentional steering operation determining process may be referred to as a “steering operation determining process”.

More specifically, the first device determines that the own vehicle SV is in the intentional steering operation status, when a yaw rate change amount AOC representing an absolute value of a value obtained by subtracting “a yaw rate at a time point a predetermined time period before a present time point” from “a yaw rate at the present time point” is equal to or larger than a threshold amount AOC1th. It should be noted that the first device uses the yaw rate as a steering index value which correlates with a steering amount by the driver. Therefore, the yaw rate used for determining whether or not the own vehicle SV is in the intentional steering operation status may be referred to as “the steering index value”.

The first device sets a threshold time period Tth to a usual threshold time period T1th when at least one of the following conditions (1) and (2) is established.

(1) The obstacle including (specified by) the obstacle point with the minimum time to collision TTC is not the continuous structure.

(2) The own vehicle SV is not in the intentional steering operation status.

On the other hand, the first device determines that a special condition is established when the obstacle including (specified by) the obstacle point with the minimum time to collision TTC is the continuous structure and the own vehicle SV is in the intentional steering operation status. In this case, the first device sets the threshold time period Tth to a steering threshold time period T2th. It should be noted that the steering threshold time period T2th is set to be shorter than the usual threshold time period T1th.

Thereafter, the first device determines whether or not the minimum time to collision TIC is equal to or shorter than the threshold time period Tth. When the minimum time to collision TTC is equal to or shorter than the threshold time period Tth, the first device determines that a support performing condition to trigger/start the collision preventing control is established, so as to perform the collision preventing control for preventing the own vehicle from colliding with the obstacle including (specified by) the obstacle point with the minimum time to collision TTC. On the other hand, when the minimum time to collision TTC is longer than the threshold time period Tth, the first device does not perform the collision preventing control. As described above, the steering threshold time period T2th is set to be shorter than the usual threshold time period T1th. Therefore, it becomes more difficult for the support performing condition to be established when the threshold time period Tth is set to the steering threshold time period T2th than when the threshold time period Tth is set to the usual threshold time period T1th.

Accordingly, the first device changes the threshold time period Tth such that the support performing condition becomes more difficult to be established when the above special condition is established than when the above special condition is not established. Therefore, the first device can reduce a possibility of performing the collision preventing control while the driver performs the intentional steering operation, to thereby be able to reduce a possibility that the collision preventing control annoys the driver.

### <Detail of Operation>

A detail of the operation of the first device will next be described.

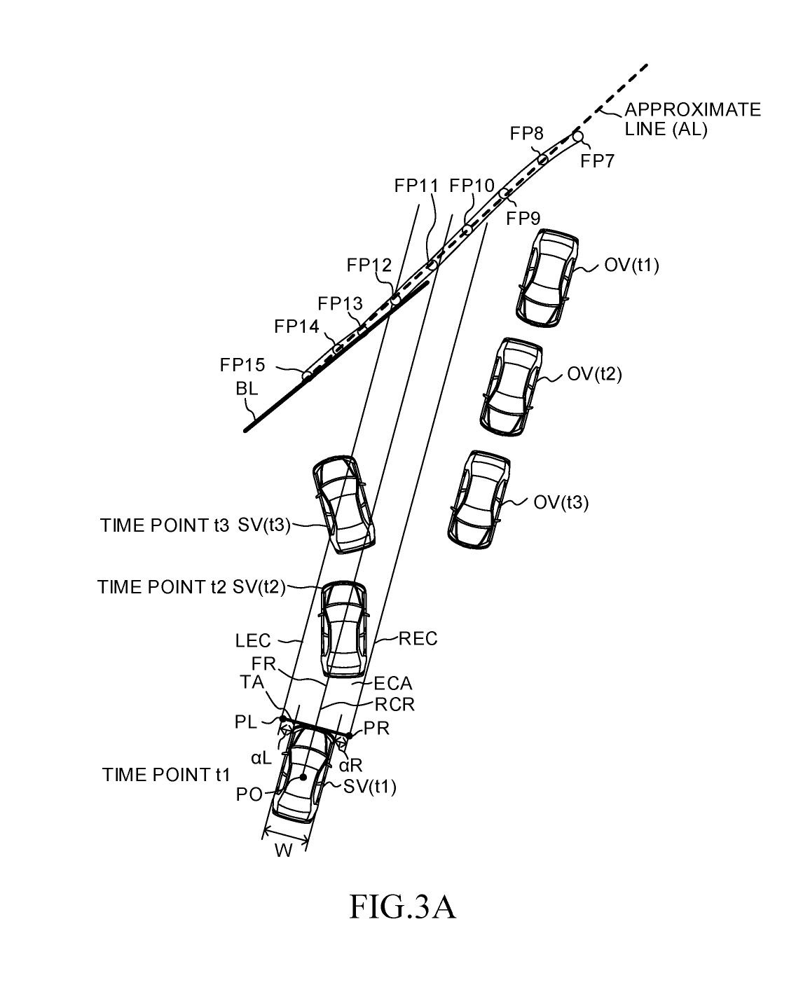

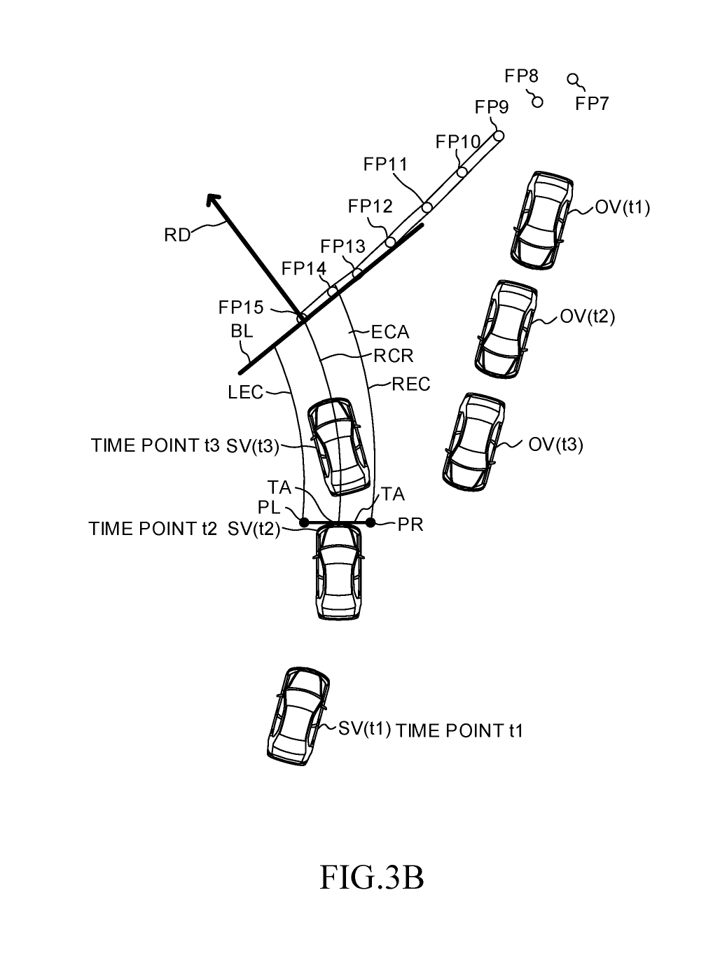

Firstly, a process for selecting/extracting the obstacle point is described with reference to FIG. 2. The first device selects, as an obstacle point(s), the feature point(s) which is predicted to have probability of colliding with the own vehicle SV from the feature point(s) included in the object information. The feature points selected as the obstacle point may include a feature point which is predicted not to collide with the own vehicle SV but to have a narrow margin of clearance between the feature point and the own vehicle SV (or to extremely approach the own vehicle SV). As described above, the first device predicts, as the predicted traveling path (course, trajectory) RCR, a traveling path (course, trajectory) along which a center point (referring to the point PO) of the wheel axis connecting a front-left wheel and a front-right wheel of the own vehicle SV will travel. Further, the first device predicts, based on the “part of the predicted traveling path RCR having the finite distance”, a predicted left traveling path LEC along which a point PL will move, and a predicted right traveling path REC along which a point PR will move. The point PL is positioned leftward by a predetermined distance αL from a left end of a body of the own vehicle SV. The point PR is positioned rightward by a predetermined distance αR from a right end of the body of the own vehicle SV. That is, the predicted left traveling path LEC is obtained by parallelly shifting the predicted traveling path RCR to the left direction of the own vehicle SV by a “distance obtained by adding a half (W/2) of a vehicle-body width W to the predetermined distance αL”. The predicted right traveling path REC is obtained by parallelly shifting the predicted traveling path RCR to the right direction of the own vehicle SV by a “distance obtained by adding a half (W/2) of the vehicle-body width W to the predetermined distance αR”. Each of the distance αL and the distance αR is longer than or equal to “0”. The distance αL and the distance αR may be the same as each other, or may be different from each other. The first device specifies, as a predicted traveling path area ECA (referring to FIGS. 3A and 3B), an area between the predicted left traveling path LEC and the predicted right traveling path REC.

Further, the first device calculates/predicts a moving trajectory of the feature point based on the past locations/positions of the feature point. The first device calculates/predicts a moving direction of the feature point in relation to the own vehicle SV, based on the calculated moving trajectory of the feature point. Subsequently, the first device selects/extracts, as the obstacle point(s) which has probability (high probability) of colliding with the own vehicle SV,

one or more of the feature points which has been in the predicted traveling path area ECA and which will intersect with a front end area TA of the own vehicle SV, and

one or more of the feature points which will be in the predicted traveling path area ECA and which will intersect with the front end area TA of the own vehicle SV,

based on the predicted traveling path area ECA, the relative relation (the relative location and the relative velocity) between the own vehicle SV and the feature point, and the moving direction of the feature point in relation to the own vehicle SV. The front end area TA is an area represented by a line segment between the point PL and the point PR.

The first device predicts the “trajectory/path along which the point PL will move” as the predicted left traveling path LEC, and predicts the “trajectory/path along which the point PR will move” as the predicted right traveling path REC. If both of the values αL and αR are positive values, the first device determines the “feature point which has been in the predicted traveling path area ECA and will intersect with the front end area TA” or the “feature point which will be in the predicted traveling path area ECA and will intersect with the front end area TA”, as the feature point with probability of passing near the left side or the right side of the own vehicle SV.” Accordingly, the first device can select/extract, as the obstacle point, the feature point with the probability of passing near the left side or the right side of the own vehicle SV.

In the example shown in FIG. 2, the feature points FP1 through FP6 have been detected, and the feature point FP4 has been selected/extracted as the obstacle point. Hereinafter, the feature point FP4 selected as the obstacle point may be referred to as an “obstacle point FP4”.

A process for calculating the time to collision TIC of the obstacle point will next be described.

After selecting the obstacle point, the first device calculates the time to collision TIC of the obstacle point by dividing the distance (the relative distance) between the own vehicle SV and the obstacle point by the relative velocity of the obstacle point in relation to the own vehicle SV.

The time to collision TTC is either a time period T1 or a time period T2, described below.

The time period T1 is a time period which it takes for the obstacle point to collide with the own vehicle SV (a time period from the present time point to a predicted collision time point).

The time period T2 is a time period which it takes for the obstacle point which has probability of passing near either of sides of the own vehicle SV to reach the closest point to the own vehicle SV (a time period from the present time point to the time point when the obstacle point most closely approaches the own vehicle SV).

The time to collision TTC is a time period which it takes for the obstacle point to reach the “front end area TA of the own vehicle SV” under an assumption that the obstacle point and the own vehicle SV move with keeping the relative velocity and the relative moving direction at the present time period.

Further, the time to collision ITC represents a time period which it takes for the first device to be able to perform the collision preventing control for preventing the collision with the “obstacle including the obstacle point” or a time period which it takes for the driver to be able to perform a collision preventing operation for preventing the collision. The time to collision TTC is a parameter representing an emergency degree, and corresponds to a necessity degree for the collision preventing control. That is, as the time to collision TTC is shorter, the necessity degree for the collision preventing control is greater/higher, and, as the time to collision TIC is longer, the necessity degree for the collision preventing control is smaller/lower. The time to collision TTC may be referred to as a “collision index value”.

Now, an outline of a continuous structure determining process is described.

After calculating the time to collision TTC of each of the obstacle points, the first device performs the continuous structure determining process for determining whether or not the “object (obstacle) including the obstacle point with the minimum time to collision TTC (that is, the obstacle point which is likely to collide with the own vehicle SV earliest or is likely to reach the closest point to the own vehicle SV earliest)” is the continuous structure. The continuous structure is the object which continuously extends for a predetermined length or longer along the lane (in which the own vehicle is traveling).

In the example shown in FIG. 2, only the feature point FP4 is selected as the obstacle point. Therefore, the obstacle point with the minimum time to collision TTC is the feature point FP4. As a result, the first device selects/designates the feature point FP4 as a base point. Then, the first device sets/specifies, as a forward direction, a traveling direction RD (an upper right direction on a paper plane of FIG. 2) of the predicted traveling path RCR at the feature point FP4. More specifically, the first device parallelly shifts the predicted traveling path RCR (translates the path RCR) in such a manner that the parallelly-shifted predicted traveling path RCR passes through the feature point FP4, and calculates/determines, as the traveling direction RD, a direction of the tangent of the parallelly-shifted predicted traveling path RCR at the feature point FP4.

Subsequently, the first device selects/designates, as a processing point, a feature point which is the closest to the base point FP4 from the feature points and which is located in a side of the traveling direction RD of a base line BL. The base line BL is perpendicular to the traveling direction RD at the base point FP4. Thereafter, the first device determines whether or not the base point FP4 and the processing point satisfy both of the following continuous point conditions (A) and (B). When the base point FP4 and the processing point satisfy both of the continuous point conditions (A) and (B), the first device selects/determines the base point FP4 and the processing point as continuous points.

(A) A value obtained by subtracting a “distance/length between the processing point and the own vehicle SV” from a “distance/length between the base point and the own vehicle SV” falls within a predetermined range.

(B) A point-to-point distance/length L representing a distance/length between the base point and the processing point is equal to or shorter than a threshold distance L1th.

In the example shown in FIG. 2, the feature point FP3 is selected as the processing point. A value (R4−R3) obtained by subtracting the “distance/length (R3) between the processing point FP3 and the own vehicle SV” from the “distance/length (R4) between the base point FP4 and the own vehicle SV” falls within the predetermined range. Therefore, the base point FP4 and the processing point FP3 satisfy the above continuous point condition (A). Further, the distance/length (L4) between the base point FP4 and the processing point FP3 is equal to or shorter than the threshold distance L1th. Therefore, the base point FP4 and the processing point FP3 satisfy the above continuous point condition (B). Accordingly, the first device selects/determines the feature points FP4 and FP3 as the continuous points.

When the base point and the processing point do not satisfy at least one of the continuous point conditions (A) and (B), the first device selects, as a new processing point, the feature point which is the closest to the base point among the feature points in the side of the traveling direction RD except/excluding the feature point which has been selected as the processing point. Thereafter, the first device determines whether or not the base point and the new processing point satisfy both of the continuous point conditions (A) and (B). In a case where the base point and the processing point that satisfy both of the continuous point conditions (A) and (B) are not found when and before the first device selects new processing point a predetermined number of times, the first device determines that the obstacle including the obstacle point with the minimum time to collision TTC is not the continuous structure.

After selecting the continuous points in the forward direction, the first device determines whether or not a total of the distances between the continuous points in the forward direction is larger/longer than a predetermined continuous structure determining distance (hereinafter, referred to as a “first threshold distance”).

When the total of the distances between the continuous points in the forward direction is equal to or shorter/smaller than the continuous structure determining distance, the first device selects, as a new base point, the processing point which has been selected as the continuous point at the last time to continue to select the continuous point in the forward direction. When the feature point FP3 is selected as the continuous point, the total (L4) of the distance between the continuous points is equal to or shorter/smaller than the continuous structure determining distance (first threshold distance). Therefore, the first device selects the feature point FP3 as the new base point, and selects the continuous point in the forward direction. As a result, the feature point FP2 is selected as the continuous point. The total (L4+L3) of the distances between the continuous points is equal to or shorter/smaller than the continuous structure determining distance. Therefore, the first device selects the feature point FP2 as the new base point, and selects the continuous point. As a result, the feature point FP1 is selected as the continuous point. The total (L4+L3+L2) of the distances between the continuous points is larger/longer than the continuous structure determining distance. Therefore, the feature point FP1 is recognized as the end point of the continuous structure in the forward direction.

Thus, when the total of the distances between the continuous points in the forward direction is larger/longer than the continuous structure determining distance, the first device determines that the obstacle including the obstacle point with the minimum time to collision TTC is the continuous structure. The first device recognizes, as an end point of the continuous structure in the forward direction, the processing point which has been selected as the continuous point at the last time.

Incidentally, the first device determines whether or not the own vehicle SV is in the intentional steering operation status, every time a predetermined time period elapses. This determining process is described with reference to FIGS. 3A and 3B. Time series positions (sequential positions) of the own vehicle SV while the driver is performing the intentional steering operation for preventing the collision with the other vehicle OV which is present in the vicinity of the continuous structure are shown in FIGS. 3A and 3B.

It is assumed that the following conditions are established in the examples shown in FIGS. 3A and 3B.

The driver starts performing the intentional steering operation for preventing the collision with the other vehicle OV at one time point between a time point t1 and a time point t2. The driver continues performing the intentional steering operation from the one time point to a time point t3.

A yaw rate Yr0 of the own vehicle SV is not generated at a time point t0 (not shown). A yaw rate Yr1 of the own vehicle SV is not generated at the time point t1 when a predetermined time period elapses from the time point t0. A yaw rate Yr2 in a counterclockwise direction of the own vehicle SV is generated at the time point t2. A yaw rate Yr3 in the counterclockwise direction of the own vehicle SU is generated at the time point t3. Further, a relationship between the yaw rates Yr1 and Yr2 satisfies the following expression.

|Yr2−Yr1|≥threshold amount AOC1th

The feature points FP7 through FP15 are selected at any one of the time points t1 through t3.

As shown in FIG. 3A, the feature points FP10 through FP12 are selected as the obstacle points at the time point t1. The obstacle point with the minimum time to collision TTC among the feature (obstacle) points FP10 through FP 12 is the feature (obstacle) point FP12.

As shown in FIG. 3B, the feature points FP14 and FP15 are selected as the obstacle points at the time points t2 and t3. The obstacle point with the minimum time to collision TTC between the feature (obstacle) points FP14 and FP 15 is the feature (obstacle) point FP15.

A running status flag described later is set to “0” at the time point t1. The minimum time to collision TTC at the time point t1 is longer than the usual threshold time period T1th, and each of the minimum times to collision TTC at the time points t2 and t3 is longer than the steering threshold time period T2th and shorter than the usual threshold time period T1th.

The other vehicle (OV(t1)-OV(t3) at the time points t1 through t3 respectively) does not intersect with the front end area TA of the own vehicle SV. Therefore, the other vehicle OV is not the obstacle in a period from the time point t1 to the time point t3.

According to the above assumption, the feature points FP7 through FP15 shown in FIG. 3A are detected at the time point t1, and the feature points FP10 through FP12 are selected as the obstacle points. Further, the obstacle point with the minimum time to collision TTC is the feature point FP12. The first device selects the feature point FP 12 as the base point to select the continuous point in the forward direction. As a result, the feature point FP11 through FP7 are sequentially selected as the continuous points in this order. When the feature point FP7 is selected as the continuous point, the total of the distance between the continuous points is longer than the continuous structure determining distance. Therefore, the first device determines that the obstacle including the obstacle point FP12 is the continuous structure. Accordingly, the set (group) including the continuous points FP7 through FP15 is selected as the continuous structure at the time point t1.

The first device executes the intentional steering operation determining process for determining whether or not the running status of the own vehicle SV is the intentional steering operation status at the time point t1. More specifically, the first device calculates, as the yaw rate change amount AOC, the absolute value (|Yr1−Yr0|) of the value obtained by subtracting “the yaw rate Yr0 of the own vehicle SV generated at the time point to” from “the yaw rate Yr1 of the own vehicle SV generated at the time point t1”. Thereafter, the first device determines whether or not the calculated yaw rate change amount AOC is equal to or larger/greater than the threshold amount AOC1th. According to the above assumption, both of the yaw rates Yr1 and Yr0 are “0”. Therefore, the yaw rate change amount AOC is “0”. Accordingly, the yaw rate change amount AOC (|Yr1−Yr0|) is smaller than the threshold amount AOC1th. The first device determines that the own vehicle SV is not in the intentional steering operation status to set the running status flag to “0”.

Now, the running status flag is described. The running status flag is set to “1” when it is determined that the own vehicle SV is in the intentional steering operation status. The running status flag continues to be “1” until a predetermined time period elapses from a time point at which it was set to “1” regardless of the yaw rate change amount AOC. While the running status flag is set at “1” (in other words, for the predetermined time period from a time point at which the own vehicle SV is determined to be in the intentional steering operation status), the first device determines/regards that the own vehicle SV is in the intentional steering operation status so as not to set the running status to “0”, even if the yaw rate change amount AOC is smaller than the threshold amount AOC1th.

The running status flag is “0” at the time point t1. Therefore, the first device sets the threshold time period Tth to the usual threshold time period T1th to determine whether or not the minimum time to collision TTC at the time period T1 is equal to or shorter than “the threshold time period Tth set to the usual threshold time period T1th”. According to the above assumption, the minimum time to collision TTC at the time point t1 is longer than the threshold time period T1th. Therefore, the first device does not start performing the collision preventing control at the time point t1.

The driver starts performing the steering operation to have the own vehicle move leftward in order to avoid the collision with the other vehicle OV at a time point between the time point t1 and the time point t2. The predicted traveling path RCR of the own vehicle SV at the time point t2 is shown in FIG. 3B.

According to the above assumption, the feature points FP7 through FP15 shown in FIG. 3B are detected at the time point t2, and the feature points FP14 and FP15 are selected as the obstacle points. Further, the obstacle point with the minimum time to collision TIC is the feature point FP15.

In the example shown in FIG. 3B, all of the feature points FP14 through FP7 except “the obstacle point FP15 selected as the base point” are located in the side of the traveling direction RD of the base line BL. The base line BL is perpendicular to the traveling direction RD at the base point which is the feature point FP15. The first device selects the feature points FP14 through FP9 as the continuous points in the forward direction of the base point FP15. When the feature point FP9 is selected as the continuous point, the total of the distances between the continuous points in the forward direction becomes longer/larger than the continuous structure determining distance. Therefore, the first device determines that the obstacle including the obstacle point FP15 is the continuous structure. In this case, the feature point FP9 is the end point of the continuous structure in the forward direction.

Accordingly, the set (group) including the continuous points FP9 through FP15 is selected as the continuous structure at the time point t2 shown in FIG. 3B.

Further, the first device calculates the yaw rate change amount AOC (|Yr2−Yr1|) at the time point t2. According to the above assumption, the yaw rate change amount (|Yr2−Yr1|) is equal to or larger than the threshold amount AOC1th. Therefore, the first device determines that the own vehicle SV is in the intentional steering operation status to set the running status flag to “1”.

At this time point, since the running status flag is set to “1”, the first device sets the threshold time period Tth to the steering threshold time period T2th to determine whether or not the minimum time to collision TTC at the time point t2 is equal to or shorter than “the threshold time period Tth set to the steering threshold time period T2th”. According to the above assumption, the minimum time to collision TIC at the time point t2 is longer than the steering threshold time period T2th. Therefore, the first device does not start performing the collision preventing control.

The minimum time to collision TTC at the time point t2 is shorter than the usual threshold time period T1th. Therefore, if the running status flag would not have been set to “1” through the intentional steering operation determining process just before the time point t2, the first device would start performing the collision preventing control at the time point t2. In this case, the collision preventing control is performed while the driver is performing the intentional steering operation. Therefore, the collision preventing control is likely to annoy the driver.

As described, the steering threshold time period T2th is shorter than the usual threshold time period T1th. Therefore, it becomes more difficult for the minimum time to collision TTC to become equal to or shorter than the threshold time period Tth (it becomes more difficult for the support performing condition to becomes satisfied/established) when the threshold time period Tth is set to the steering threshold time period T2th than when the threshold time period Tth is set to the usual threshold time period T1th. Therefore, when the obstacle is the continuous structure and the own vehicle SV is in the intentional steering operation status, “the probability that the collision preventing control for preventing the collision with the continuous structure is performed while the driver is performing the intentional steering operation” is reduced. Therefore, the probability that the collision preventing control annoys the driver can be reduced.

It is assumed that a steering angle of the steering operation at the time point t3 is the same as a steering angle at the time point t2 and a velocity of the own vehicle SV at the time point t3 is the same as a velocity of the own vehicle SV at the time point t2. Therefore, at the time point t3, the own vehicle SV travels along the predicted traveling path RCR of the own vehicle SV at the time point t2, and the predicted traveling path RCR at the time point t3 is the same as the predicted traveling path RCR at the time point t2. At the time point t3 shown in FIG. 3, similarly to the time point t2, the set (group) including the continuous points FP9 through FP15 is selected as the continuous structure.

The running status flag has been set to “1” at the time point t2. It is assumed that the time point t3 is a time point before the predetermined time period elapses from the time point t2 when the running flag was set to “1”. The yaw rate change amount AOC at the time point t3 is “0”. Therefore, the yaw rate change amount AOC at the time point t3 is equal to smaller than the threshold amount AOC1th. However, the first device determines/regards that the own vehicle SV is in the intentional steering operation status. As a result, the first device keeps the running status flag at “1” and sets the threshold time period Tth to the steering threshold time period T2th. Thereafter, the first device determines whether or not the minimum time to collision TTC at the time point t3 is equal to or shorter than “the threshold time period Tth set to the steering threshold time period T2th”. According to the above assumption, the minimum time to collision TTC at the time point t3 is longer than the threshold time period T2th. Therefore, the first device does not start performing the collision preventing control at the time point t3.

As described above, the steering angle of the own vehicle SV at the time point t3 is the same as the steering angle at the time point t2, and the velocity of the own vehicle SV at the time point t3 is the same as the velocity at the time point t2. Therefore, the yaw rate Yr3 of the own vehicle SV generated at the time point t3 is the same as the yaw rate Yr2 of the own vehicle SV generated at the time point t2. As a result, the yaw rate change amount AOC (|Yr3−Yr2|) at the time point t3 is “0”, so that the yaw rate change amount AOC(|Yr3 Yr2|) at the time point t3 is equal to or smaller than the threshold amount AOC1th. Meanwhile, the yaw rate change amount AOC is likely to continue being comparatively small while the driver is performing the steering operation after he or she has started the steering operation. Therefore, the first device keeps the running status at “0” from the time point when the first device determines that the own vehicle SV is in the intentional steering operation status (in other words, the time point at which the driver starts the intentional steering operation) to the time point when the predetermined time period elapses thereafter. Accordingly, the first device can accurately determine that the own vehicle SV is in the intentional steering operation status to set the threshold time period Tth to the steering threshold time period T2th, even during a time period when the yaw rate change amount AOC is likely to become comparatively small while the driver is performing the steering operation. Therefore, the first device can reduce “the probability that the collision preventing control for preventing the collision with the continuous structure is performed while the driver is performing the intentional steering operation” to thereby reduce the probability that the collision preventing control annoys the driver.

Time series positions of the own vehicle SV after the time point t3 are not shown in FIGS. 3A and 3B. The driver performs the steering operation such that the own vehicle SV turns to the right direction so as to prevent the own vehicle SV from colliding with the continuous structure after the time point t3.

### <Specific Operation>

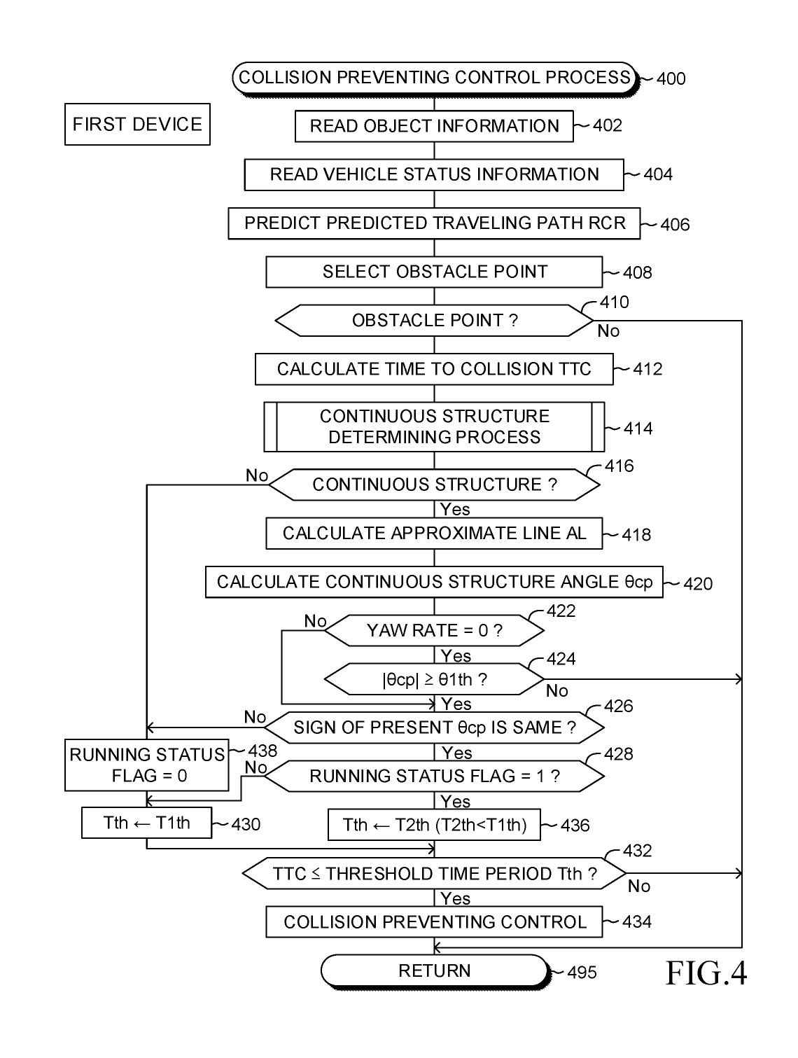

The CPU 31 of the collision preventing ECU 10 executes a routine represented by a flowchart shown in FIG. 4, every time a predetermined time period elapses. The routine shown in FIG. 4 is a routine for performing the collision preventing control with respect to the obstacle.

When a predetermined timing has come, the CPU 31 starts the process from Step 400 of FIG. 4, sequentially executes processes of Steps 402 through 408 described below in the order, and proceeds to Step 410.

Step 402: The CPU 31 reads out the object information which the camera sensor 11 obtains.

Step 404: The CPU 31 reads out the vehicle status information which the vehicle status sensor 12 obtains.

Step 406: The CPU 31 predicts the predicted traveling path RCR based on the vehicle status information which the CPU 31 reads out at Step 810, in a manner as described above.

Step 408: The CPU 31 selects the obstacle point from the feature points included in the object information based on the object information which is read out at Step 402 and the predicted traveling path RCR which is predicted at Step 406, in a manner as described above.

Subsequently, the CPU 31 proceeds to Step 410 to determine whether or not the obstacle point has been selected at Step 408. When the obstacle has not been selected at Step 408, there is no obstacle which has probability of colliding with the own vehicle SV, and thus, the CPU 31 does not need to perform the collision preventing control. Therefore, in this case, the CPU 31 makes a “No” determination at Step 410, and proceeds to Step 495 to tentatively terminate the present routine. As a result, the collision preventing control is not performed.

On the other hand, when the obstacle point has been selected at Step 408, the CPU 31 makes a “Yes” determination at Step 410 to proceed to Step 412.

Step 412: As described above, the CPU 31 calculates the time to collision TTC of each of the obstacle points which the CPU 31 has been selected at Step 408.

Subsequently, the CPU 31 proceeds to Step 414 to perform a continuous structure determining process for determining whether or not the obstacle including the obstacle point with the minimum time to collision TTC is the continuous structure. In actuality, when the CPU 31 proceeds to Step 414, the CPU 31 executes a subroutine represented by a flowchart shown in FIG. 5.

More specifically, when the CPU 31 proceeds to Step 414, the CPU 31 starts the process from Step 500 shown in FIG. 5, and proceeds to Step 505 to select, as the base point, the obstacle point with the minimum time to collision TTC. Then, the CPU 31 proceeds to Step 510.

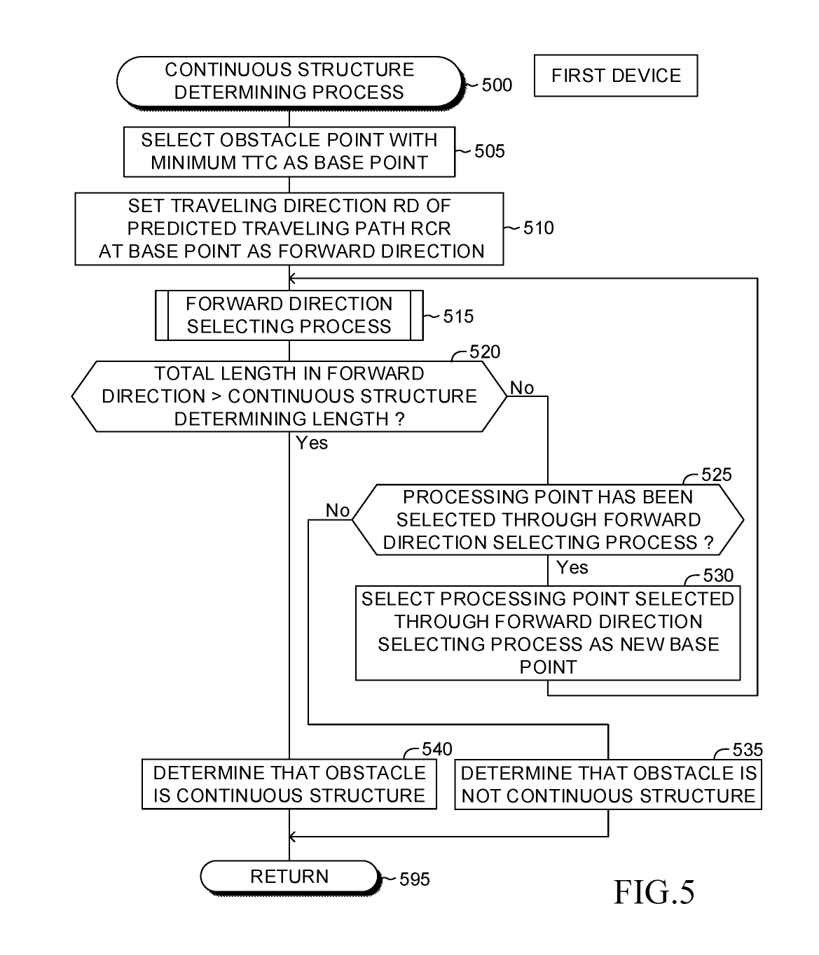

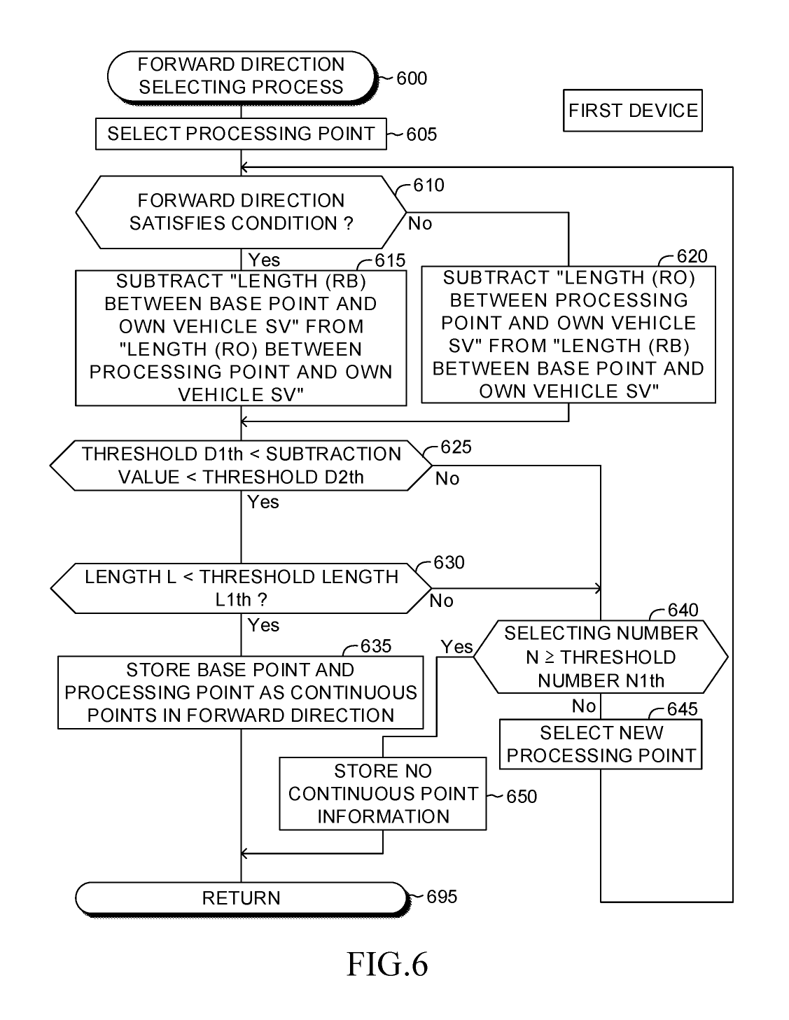

At Step 510, the CPU 31 sets, as the forward direction, the traveling direction RD of the predicted traveling path RCR at the base point, and proceeds to Step 515. At Step 515, the CPU 31 executes the forward direction selecting process for selecting the continuous points which satisfy the continuous point conditions (A) and (B) in the forward direction. In actuality, when the CPU 31 proceeds to Step 515, the CPU 31 executes a subroutine represented by a flowchart shown in FIG. 6.

More specifically, when the CPU 31 proceeds to Step 515, the CPU 31 starts the process from Step 600 shown in FIG. 6, and proceeds to Step 605. At Step 605, the CPU 31 selects, as the processing point, the feature point which is the closest to the base point among the feature points in the side of the forward direction (the traveling direction RD) of the base line BL, and proceeds to Step 610.

At Step 610, the CPU 31 determines whether or not the forward direction from the obstacle point with the minimum time to collision TTC satisfies a condition that a distance between any points located in the forward direction and the own vehicle SV becomes longer. When the forward direction from the obstacle point with the minimum time to collision TTC satisfies the condition, the CPU 31 makes a “Yes” determination at Step 610, and proceeds to Step 615. At Step 615, the CPU 31 obtains a subtraction value D by subtracting a “distance (RB) between the base point and the own vehicle SV” from a “distance (RO) between the processing point and the own vehicle SV”, and proceeds to Step 625. The “distance (RO) between the processing point and the own vehicle SV” and the “distance (RB) between the base point and the own vehicle SV” are included in the object information.

On the other hand, when the forward direction from the obstacle point with the minimum time to collision TTC satisfies a condition that a distance between any points located in the forward direction and the own vehicle SV becomes shorter, the CPU 31 makes a “No” determination at Step 610, and proceeds to Step 620. At Step 620, the CPU 31 obtains the subtraction value D by subtracting the “distance (RO) between the processing point and the own vehicle SV” from the “distance (RB) between the base point and the own vehicle SV”, and proceeds to Step 625.

At Step 625, the CPU 31 determines whether or not the subtraction value D which is calculated at Step 615 or Step 620 is larger than a threshold D1th and the subtraction value D is smaller than a threshold D2th. In other words, the CPU 31 determines whether or not the subtraction value D falls within a predetermined range. The threshold D1th is set to be smaller than the threshold D2th. The threshold D1th may be a negative value. In the present example, the threshold D1th is set to be “−0.25 m”, and the threshold D2th is set to be “6.0 m”.

Now, the reason why the threshold D1th is set to the negative value is described. The subtraction value D calculated at Step 615 or Step 620 is a value obtained by subtracting a “distance between the own vehicle SV and one of points selected from the base point and the processing point whichever closer to the vehicle SV” from a “distance between the own vehicle SV and the other point selected from the base point and the processing point whichever farther away from the vehicle SV. However, the subtraction value D may sometimes be negative even when the two feature points are selected as the base point and the processing point as described above, for the following reasons. One of the reasons is that a difference between a distance from “one of the feature points located in the vicinity of an extended line of the longitudinal axis of the own vehicle SV” to the own vehicle SV and a distance from “the other of the feature points located in the vicinity of the extended line” to the own vehicle SV is small. Another of the reasons is that the distance between the feature point and the own vehicle SV included in the object information may have an error. In view of the above, the threshold D1th is set at the negative value.

When the subtraction value D calculated at Step 615 or Step 620 is larger than the threshold D1th and the value D is smaller than the threshold D2th, in other words, the subtraction value D falls within the predetermined range, the processing point satisfies the above continuous point condition (A). In this case, the CPU 31 makes a “Yes” determination at Step 625 to proceed to Step 630.

At Step 630, the CPU 31 determines whether or not the point-to-point distance L representing the distance between the base point and the processing point is smaller/shorter than the threshold distance L1th.

When the point-to-point distance L is smaller/shorter than the threshold distance L1th, the processing point satisfies the above continuous point condition (B). In this case, the CPU 31 makes a “Yes” determination at Step 630, and proceeds to Step 635. At Step 635, the CPU 31 stores the base point and the processing point as the continuous points in the forward direction in the RAM 33, and proceeds to Step 520 in FIG. 5.

At Step 520 shown in FIG. 5, the CPU 31 determines whether or not the total of the distances between the continuous points in the forward direction is larger than the continuous structure determining distance. The continuous structure determining distance is set to an appropriate value which has been determined by experiments or the like. The continuous structure determining distance may be referred to as a “first threshold distance”.

When the total of the distances between the continuous points in the forward direction is equal to or smaller than the continuous structure determining distance, the CPU 31 makes a “No” determination at Step 520, and proceeds to Step 525. At Step 525, the CPU 31 determines whether or not the processing point has already been selected as the continuous point through the forward direction selecting process at Step 515 (referring to Step 650 described later shown in FIG. 6).

When the processing point has already been selected as the continuous point, the CPU 31 makes a “Yes” determination at Step 525, and proceeds to Step 530. At Step 530, the CPU 31 selects, as a new base point, the processing point which has already been selected as the continuous point at Step 515, and executes Step 515 again.

When no processing point has already been selected as the continuous point, the CPU 31 makes a “No” determination at Step 525, and proceeds to Step 535. At Step 535, the CPU 31 determines that the obstacle including the obstacle point with the minimum time to collision TTC is not the continuous structure. Subsequently, the CPU 31 proceeds to Step 595 to tentatively terminate the present routine. Thereafter, the CPU 31 proceeds to Step 416 shown in FIG. 4.

On the other hand, when the total of the distances between the continuous points in the forward direction is larger than the continuous structure determining distance, the CPU 31 makes a “Yes” determination at Step 520, and proceeds to Step 540. In this case, the length of the obstacle including the obstacle point with the minimum time to collision TTC along the traveling direction of the own vehicle SV is equal to or longer than the predetermined length (the continuous structure determining length). Therefore, at Step 540, the CPU 31 determines that the obstacle including the obstacle point with the minimum time to collision TIC is the continuous structure. Subsequently, the CPU 31 proceeds to Step 595 to tentatively terminate the present routine. Thereafter, the CPU 31 proceeds to Step 416 shown in FIG. 4.

Meanwhile, when the subtraction value D is equal to or smaller than the threshold D1th, or when the subtraction value D is equal to or larger than the threshold D2th (that is, when the subtraction value D does not fall within the predetermined range) at the time point when the CPU 31 executes the process at Step 625 shown in FIG. 6, the processing point does not satisfy the above continuous point condition (A). In this case, the CPU 31 makes a “No” determination at Step 625, and proceeds to Step 640.

Further, when the point-to-point distance L is equal to or larger than threshold distance L1th at the time point when the CPU 31 executes the process at Step 630, the processing point does not satisfy the continuous point condition (B). In this case, the CPU 31 makes a “No” determination at Step 630, and proceeds to Step 640.

At Step 640, the CPU 31 determines whether or not a selecting number is equal to or larger than a threshold number N1th. The selecting number N represents a number of times of selecting the “processing point which is determined not to satisfy at least one of the continuous point condition (A) and the continuous point condition (B)” with respect to the base point selected at the present time point. The threshold number T1th is an integer which is equal to or larger than “2”. For example, the threshold number T1th is “5”. When the selecting number N is smaller than the threshold number N1th, the CPU 31 makes a “No” determination at Step 640 shown in FIG. 6, and proceeds to Step 645. At Step 645, the CPU 31 selects, as the new processing point, the feature point which is the closest to the base point in the forward direction among the feature points except the feature point which has already been selected as the processing point, and returns to Step 610 to determine whether or not the new processing point is the continuous point with respect to the base point which is selected at the present time point.

In contrast, when the selecting number N is equal to or larger than the threshold number N1th at the time point when the CPU 31 executes the process at the Step 640, the CPU 31 determines that there is no feature point which is qualified to be the continuous point with respect to the base point selected at the present time point. In this case, the CPU 31 makes a “Yes” determination at Step 640, and proceeds to Step 650 to store information representing that there is no feature point which is qualified to be the continuous point with respect to the base point selected at the present time point in the RAM 33. Thereafter, the CPU 31 proceeds Step 695 to tentatively terminate the present routine. Then, the CPU 31 proceeds to Step 520 shown in FIG. 5.

In this case, the base point and the processing point have not been selected as the continuous points. Therefore, the total of the distances between the continuous points is the same as the previous total of the distances between the continuous points. Accordingly, the CPU 31 makes a “No” determination at Step 520, and proceeds to Step 525. Further, in this case, no processing point has already been selected as the continuous point. Therefore, the CPU 31 makes a “No” determination at Step 525, and proceeds to Step 535 to determine that the obstacle including the obstacle with the minimum time to collision TTC is not the continuous structure.

When the CPU 31 completes the processes of the routine shown in FIG. 5, the CPU 31 proceeds to Step 416 shown in FIG. 4. At Step 416, the CPU 31 determines whether or not the determination result of the continuous structure determining process at Step 414 represents that the obstacle including the obstacle point with the minimum time to collision TTC is the continuous structure.

When the determination result of the continuous structure determining process at Step 414 represents that the obstacle is the continuous structure, the CPU 31 makes a “Yes” determination at Step 416, and proceeds to Step 418. At Step 418, the CPU 31 calculates an approximate line AL (referring to FIG. 3A) of the continuous structure, based on locations/positions of all of the continuous points which have been selected as the components of the continuous structure with relation to the own vehicle SV, and proceeds to Step 420. The location/position of the continuous point in relation to the own vehicle SV is identified by the distance between the continuous point and the own vehicle SV and the direction of the continuous point with respect to the own vehicle SV. The first device calculates the approximate line AL using a least-square method.

The CPU 31 proceeds to Step 420 at which the CPU 31 calculates, as a continuous structure angle θcp, an angle of the approximate line AL calculated at Step 418 in relation to the longitudinal axis FR of the own vehicle SV, and proceeds to Step 422. The longitudinal axis FR which is used as a base line to calculate the continuous structure angle θcp may be referred to as “an angle base line”.

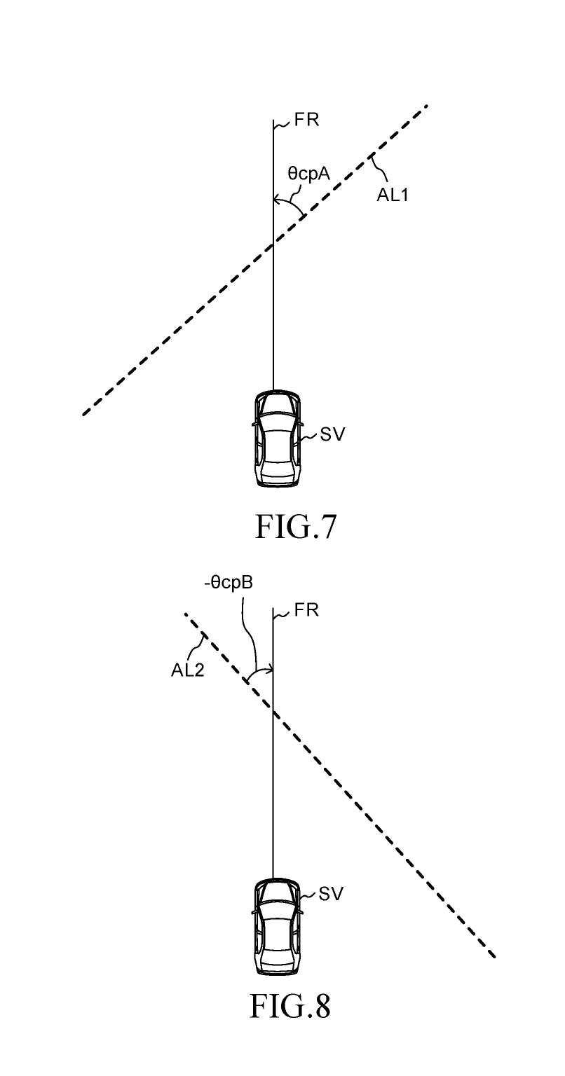

Now, a sign of the continuous structure angle θcp is described with reference to FIGS. 7 and 8. A magnitude (An absolute value) of the continuous structure angle θcp is defined to be an angle from 0 deg to 180 deg. In the example shown in FIG. 7, the direction from the approximate line AL1 to the longitudinal axis direction FR is the counterclockwise direction. In this case, the continuous structure angle θcp is the positive value (θcpA). On the other hand, as in the example shown in FIG. 8, the direction from the approximate line AL2 to the longitudinal axis direction FR is the clockwise direction. In this case, the continuous structure angle θcp is the negative value (−θcpB).

Subsequently, the CPU 31 proceeds to Step 422 shown in FIG. 4 to determine whether or not the yaw rate included in the vehicle status information which has been read out at Step 404 is “0”. In other words, the CPU 31 determines whether or not the own vehicle SV is running straight at the Step 422. When the yaw rate is “0”, the CPU 31 determines that the own vehicle SV is running straight to make a “Yes” determination at Step 422, and proceeds to Step 424.

At Step 424, the CPU 31 determines whether or not the magnitude (|θcp|) of the continuous structure angle θcp is equal to or larger than a threshold angle θ1th (θ1th>0). The detected location/position of the obstacle point is different from the real location/position of the obstacle point due to a detection error of the camera sensor 11. Therefore, although the real continuous structure is parallel to the longitudinal axis FR of the own vehicle SV which is the angle base line (the continuous structure angle θcp=0 deg), the detected continuous structure may be inclined to the longitudinal axis FR. The threshold angle θ1th is set to the maximum value of the continuous structure angle θcp of the detected continuous structure when the real/actual continuous structure is parallel to the longitudinal axis FR of the own vehicle SV, in consideration of the detection error of the camera sensor 11. For example, it is preferable that the threshold angle θ1th is set to a desirable value selected from 2 deg to 3 deg.

When the yaw rate of the own vehicle SV is “0”, the own vehicle SV is running straight, and the predicted traveling path RCR coincides with the longitudinal axis FR. Further, when the magnitude of the continuous structure angle θcp is smaller than the threshold angle θ1th, the continuous structure with the continuous structure angle θcp is regarded as being parallel to the longitudinal axis FR of the own vehicle SV. When the continuous structure is parallel to the longitudinal axis FR of the own vehicle SV and the own vehicle SV is running straight, the own vehicle does not collide with the continuous structure. Therefore, when the magnitude of the continuous structure angle θcp is smaller than the threshold angle θ1th, the CPU makes a “No” determination at Step 424, and determines that the own vehicle SV does not collide with the continuous structure. Thereafter, the CPU 31 proceeds to Step 495 to tentatively terminate the present routine. As a result, the collision preventing control is not performed.

On the other hand, when the magnitude of the continuous structure angle θcp is equal to or larger than the threshold angle θ1th, the CPU 31 makes a “Yes” determination at Step 424, and proceeds to Step 426. Further, when the yaw rate is not “0” at the time point when the CPU 31 proceeds to Step 422, the CPU 31 makes a “No” determination at Step 422, and proceeds to Step 426. When the yaw rate is not “0” in other words, when the own vehicle SV is turning, the own vehicle SV may collide with the continuous structure even if the continuous structure is parallel to the longitudinal axis FR of the own vehicle SV. Therefore, the CPU 31 proceeds to Step 426 without executing the process at Step 424.

At Step 426, the CPU 31 determines whether or not the sign of the continuous structure angle θcp calculated at Step 420 shown in FIG. 4 at the present time point is the same as the sign of the continuous structure angle θcp which was calculated at Step 420 at the previous time point (i.e., when the present routine was executed previously). In other words, at Step 426, the CPU 31 determines whether or not the direction from the approximate line AL calculated at the present time point to the longitudinal axis FR is the same as the direction from the approximate line AL calculated at the previous time point to the longitudinal axis FR. When the sign of the continuous structure angle θcp calculated at the present time point is the same as the sign of the continuous structure angle θcp calculated at the previous time point, the CPU 31 determines that the continuous structure selected/specified at the present time point is the same as the continuous structure selected/specified at the previous time point. In this case, the CPU 31 makes a “Yes” determination at Step 426 to proceed to Step 428.

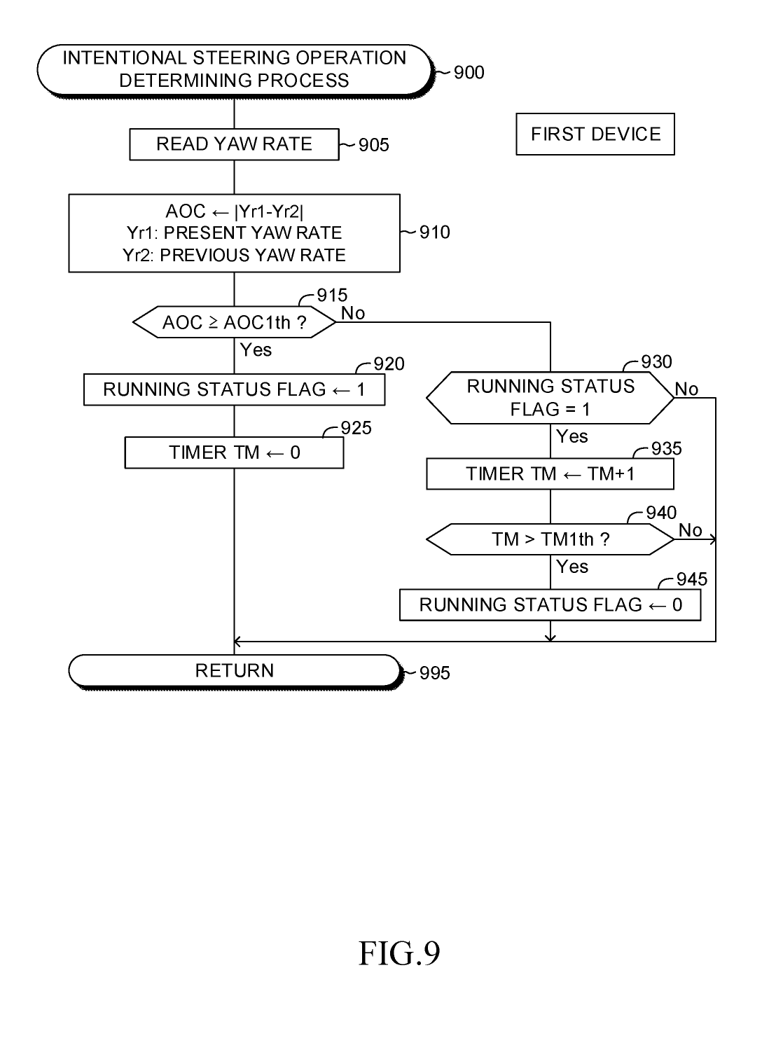

At Step 428, the CPU 31 determines whether or not the running status flag is set to “1”. When it is determined that the running status of the own vehicle SV is the intentional steering operation status through the intentional steering operation determining process (referring to FIG. 9) described later, the running status flag is set to “1”. The running status flag is kept “1” until the predetermined time period elapses from the time point when it is determined that the running status is the intentional steering operation status. When the predetermined time period elapses from the determining time point, the running status flag is set to “0”.

Now, the intentional steering operation determining process is described with reference to FIG. 9.

The CPU 31 of the collision preventing ECU 10 executes a routine represented by a flowchart shown in FIG. 9, separately from the routine represented by the flowchart shown in FIG. 4, every time a predetermined time period elapses. The routine shown in FIG. 9 is a routine for determining whether or not the running status is the intentional steering operation status.

When a predetermined timing has come, the CPU 31 starts the process from Step 900 of FIG. 9, and proceeds to Step 905 to read out the yaw rate from the yaw rate sensor included in the vehicle status sensor 12. Thereafter, the CPU 31 proceeds to Step 910.

At Step 910, the CPU 31 calculates, as the yaw rate change amount AOC, the absolute value (|Yr1−Yr2|) of the value obtained by subtracting “the yaw rate Yr2 which was read out at the previous Step 905” from “the yaw rate Yr1 which is read out at the present Step 905”. The yaw rate change amount AOC represents a change amount the present yaw rate from the previous yaw rate.

Subsequently, the CPU 31 proceeds to Step 915 to determine whether or not the yaw rate change amount AOC calculated at Step 910 is equal to or larger than the threshold amount AOC1th. When the yaw rate change amount AOC is equal to or larger than the threshold amount AOC1th, the CPU 31 determines that the own vehicle SV is in the intentional steering operation status to make a “Yes” determination at Step 915 to proceed to Step 920. At Step 920, the CPU 31 sets the running status flag to “1”, and proceeds to Step 925. At Step 925, the CPU 31 sets a timer value TM to “0” to initialize the timer value TM, and proceeds to Step 995 to tentatively terminate the present routine.

On the other hand, when the yaw rate change amount AOC is smaller than the threshold amount AOC1th, the CPU makes a “No” determination at Step 915, and proceeds to Step 930 to determine whether or not the running status flag has been set to “1”.

When the running status flag has been set to “1”, the CPU 31 makes a “Yes” determination at Step 930, and proceeds to Step 935. At Step 935, the CPU 31 obtains a value by adding “1” to the present timer value TM, and sets the timer value TM (which is a new timer value) to the obtained value to proceed to Step 940.

At Step 940, the CPU 31 determines whether or not the new timer value TM set at Step 935 is larger than a threshold timer value TM1th. When the timer value TM is equal to or smaller than the threshold timer value TM1th, the predetermined time period has not elapsed from the time point when it was determined that the own vehicle SV was in the intentional steering operation status (the time point when the running status flag was set to “1” at Step 920). Therefore, the CPU 31 presumes that the own vehicle is in the intentional steering operation status to make a “No” determination at Step 940, and proceeds to Step 995 to tentatively terminate the present routine.

The yaw rate change amount of the own vehicle SV tends to become large when and immediately after the driver starts the intentional steering operation. However, the yaw rate change amount of the own vehicle SV tends to be small while the driver continues performing the intentional steering operation. Therefore, even if the yaw rate change amount AOC is smaller than the threshold amount AOC1th, the CPU 3 1 presumes that the own vehicle SV is in the intentional steering operation status, and keeps the running status flag “1” until the predetermined period elapses from the time point when it is determined that the own vehicle SV is in the intentional steering operation status. Accordingly, the CPU 31 can reduce the probability that the collision preventing control is performed while the driver is performing the intentional steering operation, to thereby reduce the probability that the collision preventing control annoys the driver while the driver is performing the intentional steering operation.

On the other hand, when the timer value TM is larger than the threshold timer value TM1th, the predetermined time period has elapsed from the time point when the running status flag is set to “1” at Step 920. Therefore, the CPU 31 makes a “Yes” determination at Step 940, and proceeds to Step 945. At Step 945, the CPU 31 sets the running status flag to “0”, and proceeds to Step 995 to tentatively terminate the present routine.

When any one of the following conditions is established even before the predetermined time period elapses from the time point when the running status flag is set to “1”, the running status flag is set to “0” (referring to Step 438 shown in FIG. 4 described later).
It is determined that the obstacle is not the continuous structure at the present Step 416.
The sign of the continuous structure angle θcp calculated at the present time point is different from the sign of the continuous structure angle θcp calculated at the previous time point.

Referring back to FIG. 4, the collision preventing control process is continued to be described. When the running status flag has not been set to “1”, in other words, the running status flag has been set to “0”, at the time point when the CPU 31 executes the process at Step 428, the CPU 31 makes a “No” determination at the Step 428, and proceeds to Step 430. At Step 430, the CPU 31 sets the threshold time period Tth to the usual threshold time period T1th, and proceeds to Step 432.

At Step 432, the CPU 31 determines whether or not the minimum time to collision TTC is equal to or shorter/smaller than “the threshold time period Tth which is set to the usual threshold time period T1th”. When the minimum time to collision TTC is equal to or shorter/smaller than the threshold time period Tth, the CPU 31 makes a “Yes” determination at Step 432, and proceeds to Step 434 to perform the collision preventing control. Thereafter, the CPU 31 proceeds to Step 495 to tentatively terminate the present routine.

The collision preventing control includes at least one of a braking preventing control (brake prevention control) and a steering preventing control (steering prevention control). According to the braking preventing control, braking the own vehicle SV is automatically carried out to have the own vehicle SV decelerate and stop in order to prevent the own vehicle SV from colliding with the obstacle. According to the steering preventing control, the steering angle of the own vehicle SV is automatically changed in order to prevent the own vehicle SV from colliding with the obstacle.

When performing the braking preventing control, the CPU 31 calculates a target deceleration based on the velocity of the own vehicle SV and the time to collision TTC. More specifically, target deceleration information which defines a “relationship among the velocity of the own vehicle SV, the time to collision TTC, and the target deceleration” is stored in the ROM 32 in a form of a look up table (map). According to the target deceleration information, as the velocity of the own vehicle SV is higher, the (magnitude of) target deceleration is larger. According to the target deceleration information, as the time to collision TTC is smaller/shorter, the (magnitude of) target deceleration is larger.

The CPU 31 refers to the target deceleration information so as to determine the target deceleration according/corresponding to the velocity of the own vehicle SV and the time to collision TTC. Thereafter, the CPU 31 transmits the determined target deceleration to the brake ECU 20. In this case, the brake ECU 20 controls the brake actuator 22 such that an actual deceleration of the own vehicle SV coincides with the target deceleration so as to generate necessary braking force.

When performing the steering preventing control, the CPU 31 calculates a target steering angle necessary for avoiding the obstacle, and transmits the calculated target steering angle to the steering ECU 40. The steering ECU 40 controls the steering motor 42 via the motor driver 41 such that an actual steering angle coincides with the target steering angle.

When the minimum time to collision TTC is longer/larger than the threshold time period Tth at the time point when the CPU 31 executes the process of Step 436, the CPU 31 makes a “No” determination at Step 436, and proceeds to Step 495 to tentatively terminate the present routine. As a result, when the minimum time to collision TTC is longer/larger than the threshold time period Tth, the collision preventing control is not performed.

When the running status flag has been set to “1” at the time point when the CPU 31 executes the process of the Step 428, the CPU makes a “Yes” determination at Step 428, and proceeds to Step 436. At Step 436, the CPU 31 sets the threshold time period Tth to the steering threshold time period T2th, and proceeds to Step 432. The steering threshold time period T2th is set to be a value shorter than the usual threshold time period T1th. Therefore, it becomes more difficult (unlikely) for the minimum time to collision TTC to become equal to or shorter than the threshold time period Tth when the threshold time period Tth is set to the steering threshold time period T2th than when the threshold time period Tth is set to the usual threshold time period T1th. In other words, in a case where the obstacle including the obstacle point with the minimum time to collision TTC is the continuous structure, it is more difficult for the support performing condition to be established when the driver is performing the intentional steering operation than when the driver is not performing the intentional steering operation.

When the minimum time to collision TTC is equal to or shorter/smaller than “the threshold time period Tth which is set to the steering threshold time period T2th”, the CPU 31 determines a “Yes” determination at Step 432, performs the collision preventing control at Step 434, and proceeds to Step 495 to tentatively terminate the present routine.

When the sign of the present continuous structure angle θcp calculated at the present time point is different from the sign of the continuous structure angle θcp calculated at the previous time point, at the time point when the CPU 31 executes the process of Step 426, the CPU 31 makes a “No” determination at Step 426, proceeds to Step 438 to set the running status flag to “0”, and proceeds to Step 438. The descriptions of the processes after Step 430 is the same as the above, and thus are omitted.

When the sign of the continuous structure angle θcp calculated at the present time point is different from the sign of the continuous structure angle θcp calculated at the previous time point, the continuous structure extracted at the present time point is different from the continuous structure extracted at the previous time point. When the running status flag is set to “1” at the present time point, this means that the driver is performing the intentional steering operation. However, it is unclear/doubtful whether or not the driver is performing the steering operation with recognition of the continuous structure extracted at the present time point. In other words, the driver may recognize only the continuous structure extracted at the previous time point without recognizing the continuous structure extracted at the present time point. Therefore, the CPU 31 sets the running status flag to “0” at Step 438, and sets the threshold time period Tth to the usual threshold time period T1th. Accordingly, the probability that the CPU 31 performs the collision preventing control to prevent a collision with the continuous structure which the driver may not recognize can be increased.

When the obstacle including the obstacle point with the minimum time to collision TTC is not the continuous structure at the time point when the CPU 31 executes the process of the Step 416, the CPU 31 makes a “No” determination at Step 416, and proceeds to Step 438.

At Step 438, the CPU 31 sets the running status flag to “0”, and proceeds to Step 430. The descriptions of the processes after Step 430 are the same as the above so as to be omitted. In this manner, when the obstacle selected at the present time point is not the continuous structure, the CPU 31 can set the threshold time period Tth to the usual threshold time period T1th.

As understood from the above example, when the obstacle including the obstacle point is the continuous structure and the running status of the own vehicle SV is the intentional steering operation status, the first device sets the threshold time period Tth to the steering threshold time period T2th.

Therefore, it becomes more difficult (unlikely) that the collision preventing control is performed when the driver is performing the intentional steering operation than when the driver is not performing the intentional steering operation. Accordingly, the probability that the collision preventing control annoys the driver can be reduced.

### Second Embodiment

A collision preventing control device (hereinafter, referred to as a “second device”) according to a second embodiment of the present invention will next be described. When the obstacle including the obstacle point is the continuous structure and the running status of the own vehicle SV is the intentional steering operation status, the second device changes/corrects the minimum time to collision TTC in such a manner that the minimum time to collision TTC becomes larger, and determines whether or not the changed/corrected time to collision TTC is equal to or shorter/smaller than the threshold time period Tth. The second device differs from the first device only in the above respect. The threshold time period Tth is set to the usual threshold time period T1th used by the first device. The above difference is mainly described below.

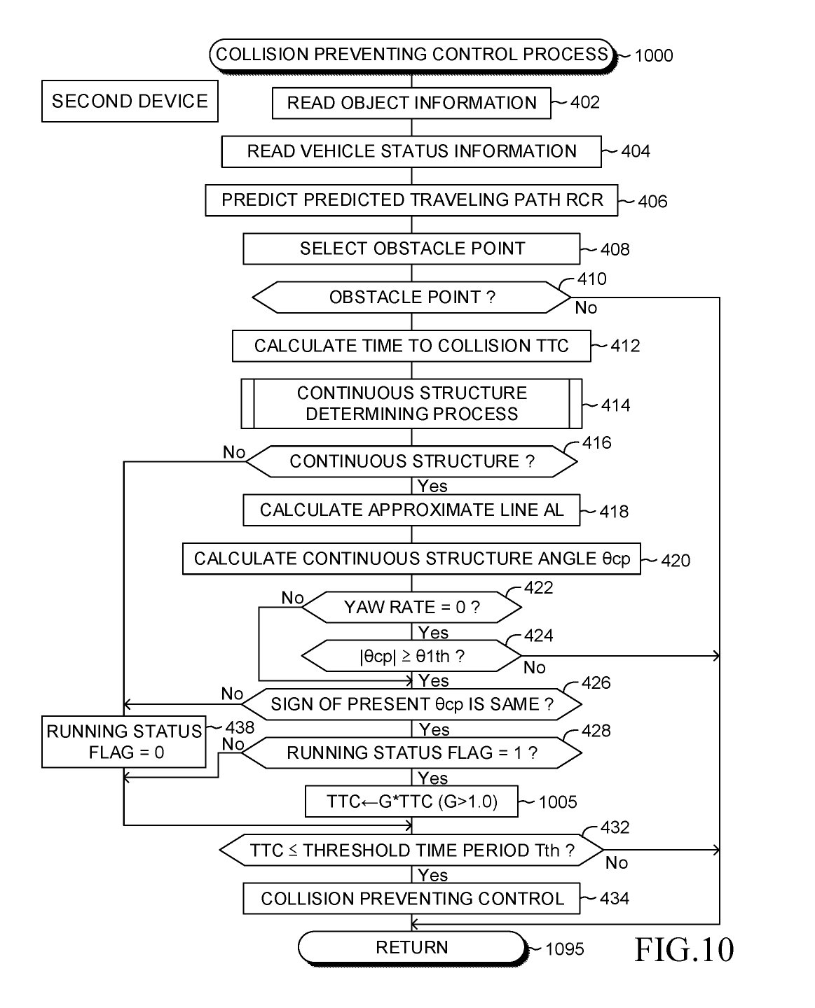

The CPU 31 of the second device executes a routine represented by a flowchart shown in FIG. 10 in place of the routine represented by the flowchart shown in FIG. 4. In FIG. 10, the same steps as the steps shown in FIG. 4 are denoted by common step symbols for the steps shown in FIG. 4, and description thereof is omitted.

When a predetermined timing has come, the CPU 31 starts the process from Step 1000 shown in FIG. 10. Thereafter, when the running status flag is not set to “1”, in other words, the running status flag is set to “0”, at the time point when the CPU 31 proceeds to Step 428, the CPU 31 makes a “No” determination at Step 428, and proceeds to Step 432. At Step 432, the CPU 31 determines whether or not the minimum time to collision TTC is equal to or shorter than the threshold time period Tth. When the minimum time to collision TIC is equal to shorter than the threshold time period Tth, the CPU 31 makes a “Yes” determination at Step 432, proceeds to Step 434 to perform the collision prevention control, and proceeds to Step 1095 to tentatively terminate the present routine. On the other hand, when the minimum time to collision TTC is longer than the threshold time period Tth, the CPU 31 makes a “No” determination at Step 432, and proceeds to Step 1095 to tentatively terminate the present routine.

Meanwhile, when the running status flag is set to “1” at the time point when the CPU 31 executes the process at Step 428, the CPU 31 makes a “Yes” determination at Step 428, and proceeds to Step 1005.

At Step 1005, the CPU 31 calculates a changed/corrected time to collision TTCg by multiplying the minimum time to collision TTC by a gain G which is set to an appropriate value larger than “1”, and proceeds to Step 432. This changed/corrected time to collision TTCg is larger than an original (pre-corrected) minimum time to collision TTC. At Step 1005, the time to collision TTC used at Step 432 is set to the changed/corrected time to collision TTCg.

At Step 432, the CPU 31 determines whether or not the changed/corrected time to collision TTC(=TTCg) is equal to or shorter/smaller than the threshold time period Tth. When the changed/corrected time to collision TTCg is equal to or shorter/smaller than the threshold time period Tth, the CPU 31 performs the collision preventing control at Step 434. In contrast, when the changed/corrected time to collision TTCg is longer/larger than the threshold time period Tth, the CPU 31 does not execute the collision preventing control.

As described above, when the obstacle including the obstacle point is the continuous structure and the running state of the own vehicle SV is the intentional steering operation status, the second device changes/corrects the “minimum time to collision TIC used for determining whether or not the collision preventing control should be performed” in such a manner that the minimum time to collision TTC becomes larger. Therefore, it becomes more difficult (unlikely) for the collision preventing control to be performed when the driver is performing the intentional steering operation than when the driver is not performing the intentional steering operation. Accordingly, the probability that the collision preventing control annoys the driver can be reduced.

### Third Embodiment

A collision preventing control device (hereinafter, referred to as a “third device”) according to a third embodiment of the present invention will next be described. Even if the point-to-point distance/length L is equal to or longer than threshold distance L1th, the third device selects “the base point and the processing point that are used to calculate the point-to-point distance/length L” as the continuous points, when that point-to-point distance/length L is equal to shorter than an interpolation distance Lc. The third device differs from the first device and the second device only in the above respect. This difference is mainly described below.

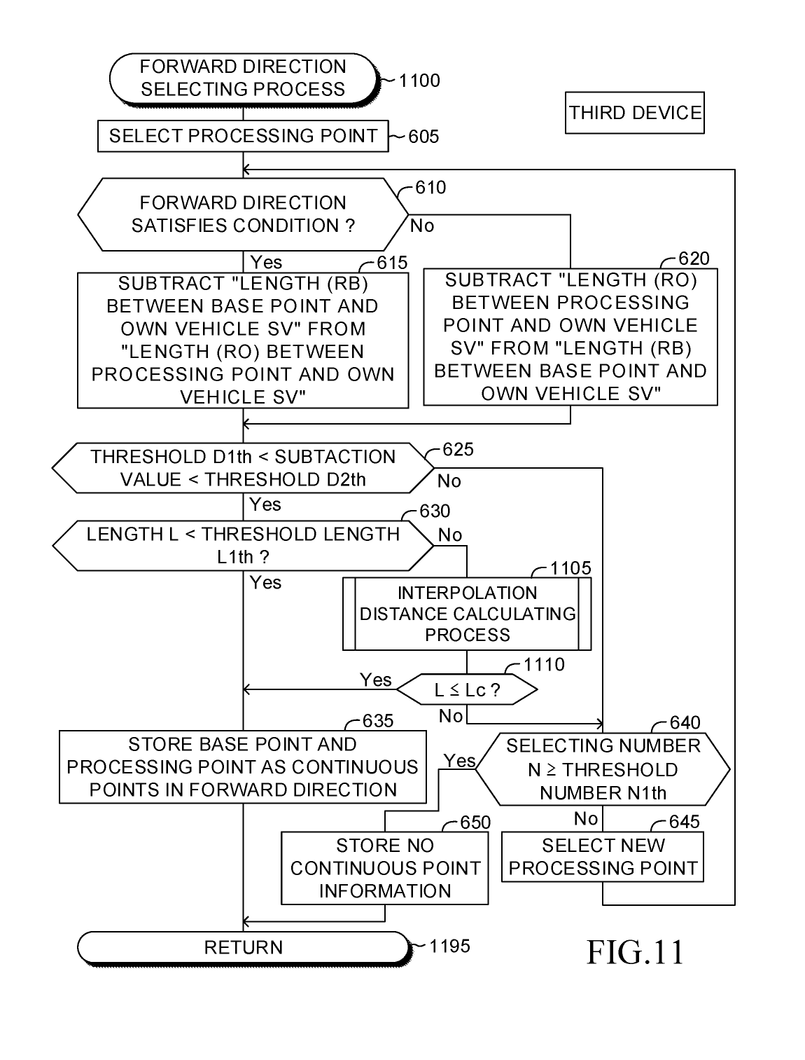

The CPU 31 of the third device executes a routine represented by a flowchart shown in FIG. 11 in place of the routine represented by a flowchart shown in FIG. 6. In FIG. 11, the same steps as the steps shown in FIG. 6 are denoted by common step symbols for the steps shown in FIG. 6, and description thereof is omitted.

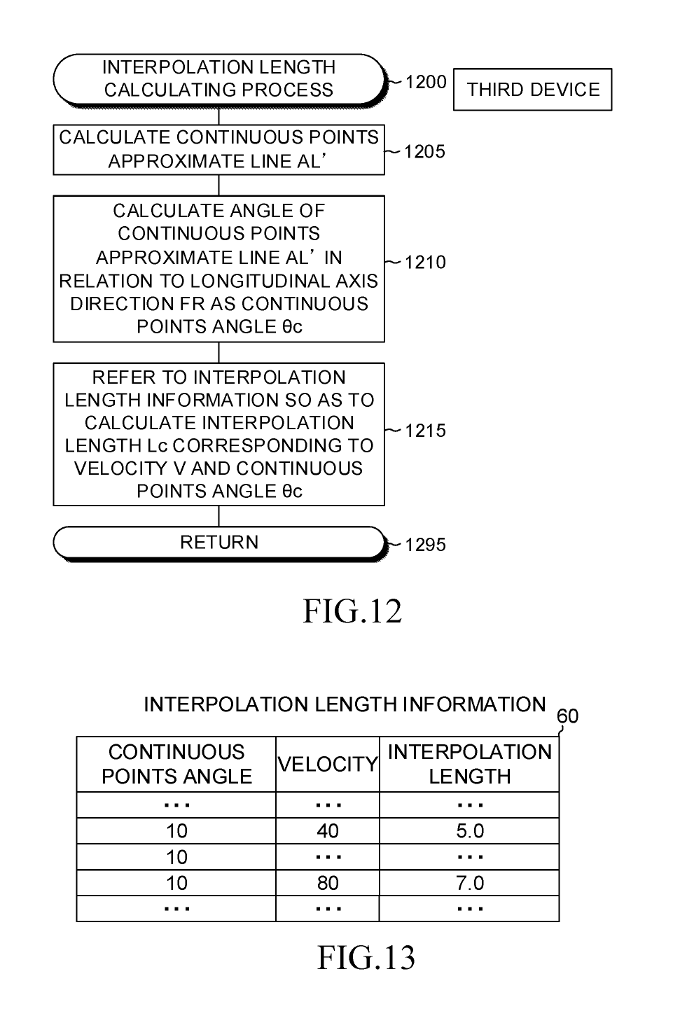

When a predetermined timing has come, the CPU 31 starts the process from Step 1100 shown in FIG. 11. Thereafter, when the point-to-point distance/length L is equal to or longer than the threshold distance L1th at the at the time point when the CPU 31 proceeds to Step 630, the CPU 31 makes a “No” determination at Step 630, and proceeds to Step 1105 to execute an interpolation distance calculating process for calculating the interpolation distance Lc. In actuality, when the CPU 31 proceeds to Step 1105, the CPU 31 executes a subroutine represented by a flowchart shown in FIG. 12.

Specifically, when the CPU 31 proceeds to Step 1105, the CPU 31 starts the process from Step 1200 shown in FIG. 12 to sequentially execute processes of Steps 1205 through 1215 in this order.

Step 1205: The CPU 31 calculates, based on the locations/positions of the continuous points which have already been selected through the forward direction selecting process, and “the base point and the processing point which are selected at the present time point” in relation to the own vehicle SV, a continuous points approximate line AL′ of those points, using the least-square method.

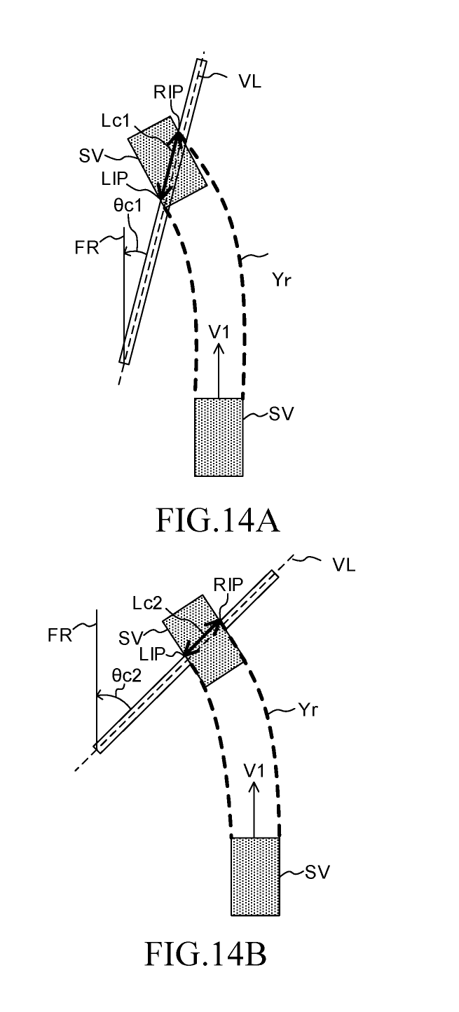

Step 1210: The CPU 31 calculates, as a continuous points angle θc (referring to θc1 in FIG. 14A and θc2 in FIG. 14B), an angle of the continuous points approximate line AL′ calculated at Step 1205 in relation to the longitudinal axis direction FR of the own vehicle SV.

Step 1215: The CPU 31 refers to interpolation distance information 60 (referred to FIG. 13) to calculate the interpolation distance Lc corresponding to the velocity V of the own vehicle SV and a magnitude of the continuous points angle θc, and proceeds to Step 1295 to tentatively terminate the present routine. Thereafter, the CPU 31 proceeds to Step 1110 shown in FIG. 11.

Here, a detail of the interpolation distance information is described with reference to FIG. 13. The interpolation distance information 60 defines a relationship among the magnitude of the continuous points angle θc, the velocity V of the own vehicle SV, and the interpolation distance Lc. The interpolation distance information 60 is stored in the RAM 32 in a form of a look up table (map). According to the interpolation distance information 60, when the magnitude of the continuous points angle θc is a constant value (remains the same), the interpolation distance Lc is longer, as the velocity V of the own vehicle SV is higher. According to the interpolation distance information 60, when the velocity V of the own vehicle SV is a constant value (remains the same), the interpolation distance Lc is shorter, as the magnitude of the continuous points angle θc is larger. For example, according to the interpolation distance information 60, when the magnitude of the continuous points angle θc is “10 deg” and the velocity V of the own vehicle SV is “40 km/h”, the interpolation distance Lc is determined to be “5.0 m”. According to the interpolation distance information 60, when the magnitude of the continuous points angle θc is “10 deg” and the velocity V of the own vehicle SV is “80 km/h”, the interpolation distance Lc is determined to be “7.0 m”.

Now, the interpolation distance Lc is described with reference to FIGS. 14A and 14B. When it is assumed that the own vehicle SV turns at the velocity V and with a predetermined emergency preventing yaw rate Yr, the interpolation distance Lc is a distance/length along a virtual line VL, and the distance/length necessary for the own vehicle SV to pass through the virtual line VL. The virtual line VL has the continuous points angle θc (θc1 in FIG. 14A, and ea in FIG. 14B). In other words, the interpolation distance/length Lc is a distance between an “intersection point LIP (referred to FIGS. 14A and 14B)” and an “intersection point RIP (referred to FIGS. 14A and 14B)”. The intersection point LIP is a point at which a left side of the own vehicle SV intersects with the virtual line VL having the continuous points angle θc when the own vehicle turns at the velocity V and with the emergency preventing yaw rate Yr. The intersection point RIP is a point at which a right side of the own vehicle SV intersects with the virtual line VL having the continuous points angle θc when the own vehicle turns at the velocity V and with the emergency preventing yaw rate Yr. The locations/positions of the own vehicle SV intersecting with the virtual line VL illustrated in FIGS. 14A and 14B are virtual locations in a case where the own vehicle SV turns with the emergency preventing yaw rate Yr toward the virtual line VL having the continuous points angle θc.

In the example of the FIG. 14A, the interpolation distance Lc is “Lc1” when the velocity V of the own vehicle SV is “V1” and the magnitude of the continuous points angle θc is “θc1”. In the example of the FIG. 146, the interpolation distance Lc is “Lc2” when the velocity V of the own vehicle SV is “V1” and the magnitude of the continuous points angle θc is “θc2”. In those examples, the emergency preventing yaw rate Yr is a predetermined fixed value regardless of the continuous points angle θc and the velocity V of the own vehicle SV. The magnitude of the continuous points angle θc2 shown in FIG. 14B is larger than the magnitude of the continuous points angle θc1 shown in FIG. 14A. Therefore, when the velocity V of the own vehicle SV shown in FIG. 14B is the same as the velocity V of the own vehicle SV shown in FIG. 14A, the interpolation distance Lc2 shown in FIG. 14B is shorter than the interpolation distance Lc1 shown in FIG. 14A.

The above interpolation distance Lc has been calculated in advance based on the velocity V of the own vehicle SV and the magnitude of the continuous points angle θc. Then, the relationship among the velocity V, the magnitude of the continuous points angle θc, and the calculated interpolation distance Lc is stored as the interpolation distance information 60 in advance. It should be noted that the threshold distance L1th used at Step 630 shown in FIG. 6 has been set to a value which is equal to or shorter/smaller than the minimum interpolation distance Lc among the interpolation distances which are included in the interpolation distance information 60.

When the point-to-point distance/length L is equal to or shorter/smaller than the interpolation distance Lc, the own vehicle SV cannot pass through the space between the base point and the processing point which are selected at the present time point. Therefore, the driver does not steer the own vehicle SV to pass through the space between the base point and the processing point. Accordingly, selecting the processing point selected at the present time point as the continuous point will cause no problem. Hence, when the point-to-point distance L is equal to or shorter/smaller than the interpolation distance Lc, the CPU 31 makes a “Yes” determination at Step 1110, and proceeds to Step 635. At Step 635, the CPU 31 selects the base point and the processing point as the continuous points in the forward direction, and proceeds to Step 1195 to tentatively terminate the present routine. Thereafter, the CPU 31 proceeds to Step 520 shown in FIG. 5.

In contrast, when the point-to-point distance/length L is longer/larger than the interpolation distance Lc, the vehicle can pass through the space between the base point and the processing point which are selected at the present time point. Therefore, the driver may steer the own vehicle SV to pass through the space between the base point and the processing point. In this case, if the CPU 31 selects the base point and the processing point as the continuous points so as to determine that the base point and the processing point are a part of the continuous structure, the unnecessary collision preventing control may be performed. In view of the above, when the point-to-point distance/length L is longer/larger than the interpolation distance Lc, the CPU 31 makes a “No” determination at Step 1110 to proceed to Step 640.

As described above, even if the point-to-point distance/length L between the base point and the processing point is equal to or longer/larger than the threshold distance L1th, when that point-to-point distance/length L is equal to or shorter/smaller than the interpolation distance Lc, the CPU 31 selects the base point and the processing point as the continuous points. In general, the feature point of a column unit of the crash barrier tends to be easily detected, and the feature point of a beam unit of the crash barrier does not tend to be easily detected. Even if the feature point of the beam unit is not detected, when the point-to-point distance L between “two feature points which sandwich the area where the feature point is not detected” is equal to or shorter/smaller than the interpolation distance Lc, the CPU 31 can recognize the area as the component of the continuous structure. Accordingly, accuracy in the determination as to whether or not the obstacle is the continuous structure can be improved.

### Modification Example of Third Device

A modification of the third device will next be described. The modification of the third device differs from the third device in the following respects.

(1) In the continuous structure determining process, when the total of the distances between the continuous points in the forward direction is larger than the continuous structure determining distance, the modification of the third device determines whether or not there is any continuous point whose continuous structure probability described later is “0” among those continuous points.

(2) When there is the continuous point whose continuous structure probability is “0” and a “distance Ls between confidence points” described later is equal to or shorter than the interpolation distance Lc, the modification of the third device determines that the obstacle is the continuous structure.

These differences are mainly described below.

In the modification of the third device, the image processing device calculates the “continuous structure probability of the extracted feature point” which indicates/represents a probability/likelihood that the extracted feature point is included in (or corresponds to) a continuous structure. The continuous structure probability is binary, namely, is either “0” or “1”. Specifically, the image processing device calculates a feature amount of an image of an area which has a predetermined size and includes the extracted feature point. The method for calculating the feature amount of the image of the area which has the predetermined size is well-known (for example, refer to Japanese Patent Application Laid-open No. 2015-166835). The image processing device sets the continuous structure probability of the feature point to “0” when a magnitude of a difference between the calculated feature amount and a continuous structure feature amount stored in the image processing device is equal to or smaller than a threshold amount. On the other hand, the image processing device sets the continuous structure probability of the feature point to “1” when the magnitude of the difference between the calculated feature amount and the continuous structure feature amount is larger than the threshold amount. The feature point whose continuous structure probability is “1” is more likely to be a component/element included in the continuous structure than the feature point whose continuous structure probability is “0”. The continuous structure feature amount is a feature amount calculated in advance based on a continuous structure's image which is prepared in advance. The continuous structure feature amount is stored in the image processing device. When the continuous structure is the crash barrier (guardrail) a continuous structure feature amount of the support column part of the barrier and a continuous structure feature amount of the beam part of the barrier are stored in the image processing device.

Further, the image processing device transmits, to the collision preventing ECU 10, the object information which includes the continuous structure probability of the feature point, every time a predetermined time period elapses.

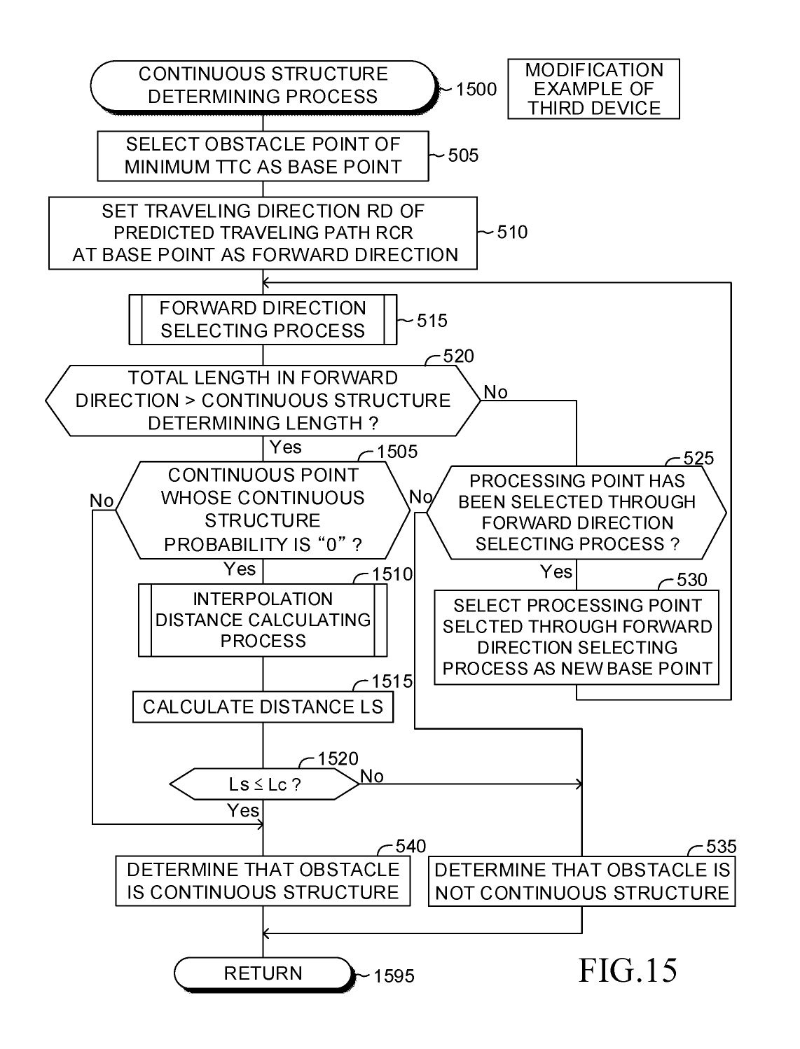

The CPU 31 of the modification executes a routine represented by a flowchart shown in FIG. 15 in place of the routine represented by the flowchart shown in FIG. 5. In FIG. 15, the same steps as the steps shown in FIG. 5 are denoted by common step symbols for the steps shown in FIG. 5, and description thereof is omitted.

When the CPU 31 proceeds to Step 414 shown in FIG. 4, the CPU 31 starts the process from Step 1500 shown in FIG. 15. The CPU 31 sequentially executes processes of Steps 505 through 515 in this order to select the continuous points in the forward direction, and proceeds to Step 520. When the total of the distances between the continuous points in the forward direction is larger than the continuous structure determining distance, the CPU 31 makes a “Yes” determination at Step 520, and proceeds to Step 1505.

At Step 1505, the CPU 31 determines whether or not there is any continuous point whose continuous structure probability is “0” among the continuous points selected at Step 515. As described above, the continuous structure probability of each of the feature points is included in the object information.

When there is no continuous point whose continuous structure probability is “0” among the continuous points selected at Step 515, the CPU 31 makes a “No” determination at Step 1505, and directly proceeds to Step 540 to determine that the obstacle including the obstacle point with the minimum time to collision TTC is the continuous structure. Thereafter, the CPU 31 proceeds to Step 1595 to tentatively terminate the present routine, and proceeds to Step 416 shown in FIG. 4.

On the other hand, when there is the continuous point whose continuous structure probability is “0” among the continuous points selected at Step 515, the CPU 31 makes a “Yes” determination at Step 1505, and proceeds to Step 1510. At Step 1510, the CPU 31 executes the interpolation distance calculating process. In actuality, when the CPU 31 proceeds to Step 1510, the CPU 31 executes the subroutine represented by the flowchart shown in FIG. 12. At Step 1205 of this interpolation distance calculating process, the CPU 31 calculates the continuous points approximate line AL′ of the continuous points selected at Step 515 shown in FIG. 15. The other processes (Step 1210 and Step 1215) of the interpolation distance calculating process are the same as those processes which have been described in the third embodiment. Therefore, the detailed descriptions of those processes are omitted.

Thereafter, the CPU 31 proceeds to Step 1515 to calculate the distance Ls between confidence points, and proceeds to Step 1520. The distance Ls between confidence points represents a distance between two continuous points each of which continuous structure probability is “1” and which sandwich the continuous point(s) whose continuous structure probability is “0”. More specifically, when there is only one continuous point whose continuous structure probability is “0”, the CPU 31 calculates, as the distance Ls between the confidence points, a distance between the “continuous point whose continuous structure probability is “1” and which is the closest to the continuous point whose continuous structure probability is “0” in the forward direction” and the “continuous point whose continuous structure probability is “1” and which is the closest to the continuous point whose continuous structure probability is “0” in the opposite direction”, When there are a plurality of the continuous points each of which continuous structure probability is “0” and which are adjacent to each other, the CPU 31 calculates, as the distance Ls between the confidence points, a distance between the “continuous point whose continuous structure probability is “1” and which is, in the forward direction, closest to the continuous point which is located at the end in the forward direction among the continuous points each of which continuous structure probability is “0” and which are adjacent to each other” and the “continuous point whose continuous structure probability is “1” and which is, in the opposite direction, closest to the continuous point which is located at the end in the opposite direction among the continuous points each of which continuous structure probability is “0” and which are adjacent to each other”.

At Step 1520, the CPU 31 determines whether or not the distance Ls between the continuous points calculated at Step 1515 is equal to or shorter/smaller than the interpolation distance Lc calculated at Step 1510. When the distance Ls between confidence points is equal to or shorter/smaller than the interpolation distance Lc, the own vehicle SV cannot pass through the space where the continuous point whose continuous structure probability is “0” is located. Therefore, in this case, the driver does not steer the own vehicle SV to pass through that space. Accordingly, recognizing that space as the component of the continuous structure will cause no problem. In view of the above, when the distance Ls between the confidence points is equal to or shorter/smaller than the interpolation distance Lc, the CPU 31 makes a “Yes” determination at Step 1520 to proceed to Step 540. At Step 540, the CPU 31 determines that the obstacle is the continuous structure. Thereafter, the CPU 31 proceeds to Step 1595 to tentatively terminate the present routine, and proceeds to Step 416 shown in FIG. 4.

On the other hand, when the distance Ls between the confidence points is longer/larger than the interpolation distance Lc, the vehicle can pass through the space where the continuous point whose continuous structure probability is “0” is located. Therefore, the driver may steer the own vehicle SV to pass through that space. If the CPU 31 recognizes the space as the component of the continuous structure, the unnecessary collision preventing control may be performed. Accordingly, when the distance Ls between the confidence points is longer/larger than the interpolation distance Lc, the CPU 31 makes a “No” determination at Step 1520. In other words, the CPU 31 determines that the “space where the continuous point whose continuous structure probability is “0” is located” is not the component of the continuous structure. As a result, the total of the distances between the continuous points in the forward direction becomes equal to or smaller than the continuous structure determining distance. Thus, the CPU 31 proceeds to Step 535 to determine that the obstacle including the obstacle point whose time to collision TTC is minimum is not the continuous structure. Subsequently, the CPU 31 proceeds to Step 1595 to tentatively terminate the present routine. Thereafter, the CPU 31 proceeds to Step 416 shown in FIG. 4.

The present invention is not limited to the above-mentioned embodiments, and various changes are possible within the range not departing from the object of the present invention. In the intentional steering operation determining process (referring to FIG. 9), the first device and the second device use the yaw rate as the steering index value which correlates with the steering amount by the driver. Further, the first device and the second device determine whether or not the yaw rate change amount AOC is equal to or larger than the threshold amount AOC1th to determine whether or not the own vehicle SV is in the intentional steering operation status. The steering index value used for the intentional steering operation determining process is not limited to the yaw rate. For example, the steering angle of each of the steered wheels detected by the steering angle sensor may be used as the steering index value in place of the yaw rate. As described above, the steering angel of each of the steered wheels is included in the vehicle status information.

More specifically, the CPU 31 reads out the steering angle of each of the steered wheels detected by “the steering angle sensor included in the vehicle status sensor 12” at Step 905 shown in FIG. 9, and proceeds to Step 910. At Step 910, the CPU 31 calculates, as a steering angle change amount AOC′, an absolute value of a value obtained by subtracting “the steering angle which was read out at the previous Step 905” from “the steering angle which is read out at the present Step 905”.

Subsequently, the CPU 31 proceeds to Step 915 to determine whether or not the steering angle change amount AOC′ is equal to or larger than a threshold amount AOC2th. When the steering angle change amount AOC′ is equal to or larger than a threshold amount AOC2th, the CPU 31 determines that the own vehicle SV is in the intentional steering operation status, and makes a “Yes” determination at Step 915 to proceed the processes after Step 920. The descriptions of the processes after Step 920 are the same as the process shown in FIG. 9, and thus are omitted.

On the other hand, when the steering angle change amount AOC′ is smaller than the threshold amount AOC2th, the CPU 31 makes a “No” determination at Step 915, and proceeds to the processes after Step 930. The descriptions of the processes after Step 930 are the same as the process shown in FIG. 9, and thus are omitted.

In the above embodiments, the time to collision is used as the collision index value representing the emergency degree. However, the collision index value is not limited to the time to collision TTC. For example, the CPU 31 may calculate a target deceleration of the own vehicle SV for each of the obstacle points to prevent the collision with each of the obstacle points, in place of the time to collision for each of the obstacle points at Step 412 shown in FIG. 4 and FIG. 10.

The emergency degree becomes higher as the time to collision TC becomes shorter. In contrast, the emergency degree becomes higher as the target deceleration becomes larger.

Therefore, when the CPU 31 proceeds to Step 414, the CPU 31 determines whether or not the obstacle point with the “maximum” target deceleration is the continuous structure. Further, when the CPU 31 proceeds to Step 432, the CPU 31 determines whether or not the maximum target deceleration is equal to or larger than a threshold deceleration Vth. When the maximum target deceleration is equal to or larger than the threshold deceleration Vth, the CPU 31 makes a “Yes” determination at Step 432, and performs the collision preventing control. On the other hand, when the maximum target deceleration is smaller than the threshold deceleration Vth, the CPU 31 makes a “No” determination at Step 432, and does not perform the collision preventing control.

If the first device uses the target deceleration as the collision index value, it sets a threshold deceleration Vth to a steering threshold deceleration V2th at Step 436 shown in FIG. 4, when the obstacle including the obstacle point with the maximum target deceleration is the continuous structure and the own vehicle SV is in the intentional steering operation status. The steering threshold deceleration V2th is larger than a usual threshold deceleration V1th. Therefore, it becomes more difficult (unlikely) that the support performing condition becomes established when the special condition is established than when the special condition is not established.

If the second device uses the target deceleration as the collision index value, it calculates, at Step 1005 shown in FIG. 10, a changed/corrected target deceleration by multiplying the maximum target deceleration by a gain G which is set to an appropriate value which is a positive value and which is smaller than “1”, and proceeds to Step 432. This changed/corrected target deceleration is smaller than an original (pre-corrected) maximum target deceleration. Therefore, it becomes more difficult for the support performing condition to be established when the special condition is established than when the special condition is not established.

Further, when the CPU 31 makes a “Yes” determination at Step 520 shown in FIG. 5, the CPU 31 may execute an opposite direction selecting process for selecting continuous points in an opposite direction which is opposite to the forward direction. The opposite direction selecting process is the same as the forward direction selecting process shown in FIG. 6. Therefore, the description of the opposite direction selecting process is omitted.

Further, the CPU 31 performs the collision preventing control including at least one of the braking prevention control and the steering prevention control at Step 434 shown in FIG. 4 or FIG. 10. However, the collision preventing control is not limited thereto.

For example, the first device and the second device may perform, as the collision preventing control, displaying control for displaying an alert screen on an display unit (not shown). The example of the display unit is a head-up-display. The alert screen guides the driver's eyes/sight to the direction of the obstacle point whose minimum time to collision TTC is equal to or shorter than the threshold time period Tth. In this manner, the driver's eyes is guided to the direction of the obstacle point, and thus, the driver can start a steering operation to prevent the own vehicle SV from colliding with the obstacle including the obstacle point as soon as possible. Further, the first device and the second device may perform, as the collision preventing control, outputting control for generating an alarm from a speaker (not shown).

The first device and the second device acquires the distance between the feature point and the own vehicle SV based on only the object information obtained from the camera sensor 11. The first device and the second device may acquire the distance between the feature point and the own vehicle SV based on object information obtained from radar sensors (not shown) in addition to the object information obtained from the camera sensor 11. For example, a front sensor is arranged at a center location on a front bumper of the own vehicle SV in the width direction, one front side sensor is arranged at a right corner on the front bumper of the own vehicle SV, and another front side sensor is arranged at a left corner on the front bumper of the own vehicle SV. These radar sensors are collectively referred to as “radar sensors”. Each of the radar sensors radiates a radio wave in a millimeter waveband (hereinafter referred to as “millimeter wave”). When an object is present within a radiation range of the millimeter wave, the object reflects the millimeter wave radiated from the radar sensors. Each of the radar sensors receives the reflected wave, and detects/measures the distance/length between a “point (referred to as “reflection point”) which is included in the object and at which the millimeter wave is reflected” and the “own vehicle SV”, the direction of the reflection point in relation to the own vehicle SV, and the relative velocity of the reflection point in relation to the own vehicle SV, based on the reflected wave. The radar sensors transmit, to the collision preventing ECU 10, the objection information including location information and the relative velocity of the reflection point in relation to the own vehicle SV, every time a predetermined time period elapses. The location information includes the distance/length between the reflection point and the own vehicle SV, and the direction of the reflection point in relation to the own vehicle SV.

When the feature point included in the object information from the camera sensor 11 is identified with the reflection point included in the object information from the radar sensors, the first device and the second device use the direction of the feature point included in the object information from the camera sensors 11 as the direction of the feature point in relation to the own vehicle SV. Further, in this case, the first device and the second device use the distance/length between “the reflection point is identified with the feature point and included in the object information from the radar sensor” and “the own vehicle SV”, as the distance/length between the feature point and the own vehicle SV. This is because a detection accuracy of the direction by the camera sensor 11 is higher than a detection accuracy of the direction by the radar sensors, and a detection accuracy of the distance/length by the radar sensors is higher than a detection accuracy of the distance/length by the camera sensor 11. Further, the first device and the second device can use the relative velocity of the reflection point included in the object information from the radar sensor, as the relative velocity of the feature point in relation to the own vehicle SV. According to the above method, the first device and the second device can calculate the location and the relative velocity of the feature point more accurately.

Further, in the above descriptions, the continuous structure probability of the feature point is either “0” or “1”, however, the continuous structure probability is not limited to this. For example, the image processing unit of the camera sensor 11 may calculate the continuous structure probability whose value is varied within a range between “0” and “1”, based on a feature amount of the image of a predetermined sized area including the feature point and the continuous structure feature amount.

In this case, at Step 1505 shown in FIG. 15, the CPU 31 determines whether or not there is a continuous point whose continuous structure probability is equal to or lower/smaller than a threshold probability Pith among the selected continuous points. When there is the continuous point whose continuous structure probability is equal to or lower/smaller than the threshold probability Pith, the CPU 31 makes a “Yes” determination at Step 1505. On the other hand, when there is no continuous point whose continuous structure probability is equal to or lower/smaller than the threshold probability Pith, the CPU 31 makes a “No” determination at Step 1505.

Further, at Step 420 shown in FIG. 4, the continuous structure angle θcp is calculated as the angle of the approximate line AL of the continuous structure in relation to the angle base line which is the longitudinal axis FR passing through the center in the width direction of the own vehicle SV. However, the angle base line may be any line which passes through any point in the width direction of the own vehicle SV, as long as the line is parallel to the longitudinal axis.

Further, in the above descriptions, the continuous structure angle θcp is the positive value when the direction from the approximate line AL to the longitudinal axis FR is the counterclockwise direction, and the continuous structure angle θcp is the negative value when the direction from the approximate line AL to the longitudinal axis FR is the clockwise direction. However, the continuous structure angle θcp may be the positive value when the direction from the approximate line AL to the longitudinal axis FR is the clockwise direction, and the continuous structure angle θcp may be the negative value when the direction from the approximate line AL to the longitudinal axis FR is the counterclockwise direction.

What is claimed is:

1. A collision preventing control device having a collision preventing control unit for determining that a support performing condition is established when a relationship between a predetermined threshold and a collision index value representing emergency degree of a collision between an object which has a high probability of colliding with an own vehicle and the own vehicle satisfies a predetermined relationship, to perform a collision preventing control including at least one of a control for changing running behavior of the own vehicle to prevent the collision and a control for displaying an alert screen to make a driver pay attention to the object, the collision preventing control unit comprising:
a continuous structure determining unit for determining whether or not the object is a continuous structure whose length is equal to or longer than a predetermined length;
a steering operation determining unit for determining whether or not a running status of the own vehicle is a steering operation running status that the own vehicle is running with a steering operation performed by the driver; and
a condition changing unit for changing at least one of the collision index value and the predetermined threshold such that the support performing condition becomes more difficult to be established when a specific condition that the object is determined to be the continuous structure and the running status is determined to be the steering operation running status is established than when the specific condition is not established.

2. The collision preventing control device according to claim 1,
wherein the steering operation determining unit is configured to:
obtain a steering index value correlating with a steering amount of the steering operation, every time a first predetermined time period elapses; and
determine that the running status is the steering operation running status when a change amount in the steering index value is equal to or larger than a threshold amount, the change amount correlating with a magnitude of a difference between a steering index value obtained at a present time point and a steering index value obtained at a time point the first predetermined time period before the present time period.

3. The collision preventing control device according to claim 2,
wherein the steering operation determining unit is configured to use either a yaw rate which is generated in the own vehicle or a steering angle of a steering wheel of the own vehicle, as the steering index value.

4. The collision preventing control device according to claim 2,
wherein the steering operation determining unit is configured to continue determining that the running status is the steering operation running status from a first time point when the change amount in the steering index value becomes equal to or larger than the threshold amount till a second time point when a second predetermined time period elapses from the first time point.

5. The collision preventing control device according to claim 4,
wherein the steering operation determining unit is configured to determine that the running status is not the steering status, when the continuous structure at the present time point becomes different from the continuous structure at the time point when the object was determined to be the continuous structure by the continuous structure determining unit so that the specific condition became established, in a period from the first time point till the second time point.

6. The collision preventing control device according to claim 1,
wherein the collision preventing control unit is configured to prohibit itself from performing the collision preventing control when the own vehicle is running straight and a magnitude of an angle of the continuous structure in relation to the own vehicle is smaller than a threshold angle.
